(19) United States
(12) Patent Application Publication
(10) Pub. No.: US 2026/0237952 A1
(43) Pub. Date: Aug. 13, 2026

(54) AUTO FEEDING FOR HAND TOOL

(71) Applicant: Hubbell Incorporated, Shelton, CT (US)

(72) Inventor: Chandru Ganeson, Tamil Nadu (IN)

(21) Appl. No.: 19/539,759

(22) Filed: Feb. 13, 2026

Related U.S. Application Data
(60) Provisional application No. 63/757,883, filed on Feb. 13, 2025.
(60) Provisional application No. 63/883,747, filed on Sep. 18, 2025.

(51) Int. Cl. H01R 43/042; B25B 27/10; H01R 43/055

(52) U.S. Cl. CPC H01R 43/0421; B25B 27/10; H01R 43/055

(57) ABSTRACT

A handheld crimping tool that includes a tool body, a ram, and a drive system. The tool body has a housing and a working end. The ram is movably positioned within the housing between a retracted position and an extended position. The ram is closer to the working end in the extended position. The drive system includes a sprocket rotatably positioned within the housing. The sprocket can rotate as the ram moves from the extended position to the retracted position.

### CROSS-REFERENCE TO RELATED APPLICATIONS

This application claims the benefit of U.S. Provisional Application No. 63/883,747, filed Sep. 18, 2025, and U.S. Provisional Application No. 63/757,883, filed Feb. 13, 2025, both of which are incorporated herein by reference in their entirety.

### FIELD

The present disclosure relates to a handheld power tool, and more specifically the present disclosure relates to an automatic hand tool.

### BACKGROUND

Electrical conductors (e.g., wires) may be crimped so that they are joined together. The crimping process may be effectuated by a tool operated by a technician. There are currently two main types of tools that a technician can use.

The first type is a bench-mounted tool, which is generally a large power tool that is fixably mounted in place. The bench-mounted tool may have an automatic-feed terminal. For example, crimps may be automatically passed through the tool (e.g., on a mylar sheet) allowing a technician to automatically move from one crimp to the next. However, because the tool is fixed in place, a technician is unable to work in remote jobsites or maneuver the tool into small areas.

The second type of tool is a handheld tool, which can be manual or battery powered. In either instance, the tool may be portable permitting the technician to transport the tool and/or maneuver it into small spaces. However, these tools are not automatic, and thus do not provide the continuous and repeatable action of the bench-mounted tool. In other words, a crimp must be repositioned after each use to prepare for the next use, instead of a new crimp being automatically fed into position like in the bench-mounted tool. A need therefore exists for the automated features of a bench-mounted tool to be incorporated into the handheld tool.

### SUMMARY

Various forms of the present disclosure can overcome various of the aforementioned and other disadvantages associated with known power hand tools and offer new advantages as well.

According to one aspect of various forms of the present disclosure there is provided a power tool for performing a crimping operation.

According to another aspect of various forms of the present disclosure, there is provided a power tool that includes a tool head and a ram that moves relative to the tool head. The power tool can automatically position a connector to be crimped between the tool head and the ram.

According to another aspect of various forms of the present disclosure, there is provided a handheld crimping tool that includes a tool body, a ram, and a drive system. The tool body has a housing and a working end. The ram is movably positioned within the housing between a retracted position and an extended position. The ram is closer to the working end in the extended position. The drive system includes a sprocket rotatably positioned within the housing. The sprocket can rotate as the ram moves from the extended position to the retracted position.

According to another aspect of various forms of the present disclosure, there is provided a handheld crimping tool that includes a tool body, a ram, a chamber, and a drive system. The tool body has a housing and a working end. The ram is movable relative to the housing between a retracted position and an extended position. The ram is closer to the working end in the extended position. The chamber is disposed within the housing and can receive a plurality of terminals. The drive system is disposed within the chamber. Movement of the ram from the extended position to the retracted position can advance the drive system. Movement of the ram toward the extended position can crimp a first terminal of the plurality of terminals. Advancement of the drive system can automatically index a successive terminal of the plurality of terminals toward the working end.

According to another aspect of various forms of the present disclosure, there is provided a handheld crimping tool that includes a tool body, a ram, and a drive system. The tool body has a housing and a working end. The ram is movable relative to the housing between a retracted position and an extended position. The ram is closer to the working end in the extended position. The drive system includes a belt rotatably driven within the housing. The belt includes a plurality of tines. The belt can rotate as the ram moves from the extended position to the retracted position. Movement of the ram toward the extended position can crimp a terminal. Rotation of the belt can automatically index a successive terminal toward the working end.

According to another aspect of various forms of the present disclosure, there is provided a handheld crimping tool that includes a tool body, a drive screw, and a crimp lever. The tool body has a housing and a working end. The drive screw is movably positioned within the housing between a retracted position and an extended position. The drive screw is coupled to an actuator that can move with the drive screw. The actuator includes a first portion and a second portion that has a latch. The crimp lever is coupled to the first portion of the actuator and can pivot between an open position and a crimp position with the movement of the actuator. Movement of the drive screw toward the extended position can cause the crimp lever to move toward the crimp position and crimp a terminal. The latch can cause the second portion to rotate to automatically index a successive terminal toward the working end.

In one general aspect, a handheld crimping tool may include a tool body that has a housing and a working end. The handheld crimping tool may also include a pair of jaws that are movable relative to the working end between a closed position and an opened position. The tool may furthermore include a chamber disposed within the housing that can receive a plurality of terminals. The tool may in addition include a drive system disposed within the chamber. Movement of the pair of jaws from the closed position to the opened position can advance the drive system. Movement of the pair of jaws toward the closed position can crimp a first terminal of the plurality of terminals. Advancement of the drive system can automatically index a successive terminal of the plurality of terminals toward the working end.

In one general aspect, a handheld crimping tool may include a tool body that has a channel and a working end. The handheld crimping tool also includes a pair of jaws movable relative to the working end between a closed position and an opened position. A cover is removably connected to the tool body to enclose a chamber configured to receive a plurality of terminals. The handheld crimping tool further includes a drive system disposed within the chamber. Movement of the pair of jaws from the closed position to the opened position can advance the drive system. Movement of the pair of jaws toward the closed position can crimp a first terminal of the plurality of terminals. Advancement of the drive system can automatically index a successive terminal of the plurality of terminals toward the working end.

According to another aspect, there is a handheld crimping tool may include a tool body that has a channel and a working end. The handheld crimping tool also includes a jaw element that is movable relative to the working end between a first position and an second position. A cover is removably connected to the tool body to enclose a chamber configured to receive a plurality of terminals. The handheld crimping tool further includes a drive system disposed within the chamber. The handheld crimping tool also includes a spool disposed within the chamber proximate to the working end. The plurality of terminals is wrapped around the spool. The spool is connected to the drive system. Movement of the jaw element from the first position to the second position can advance the drive system. Movement of the jaw element toward the closed position can crimp a first terminal of the plurality of terminals. Advancement of the drive system can rotate the spool to automatically index a successive terminal of the plurality of terminals toward the working end.

According to another aspect of various forms of the present disclosure, there is provided a method of using an automatic feeder tool to crimp terminals. The method includes connecting a first terminal die to a working end of a tool body and loading a plurality of first terminals into a chamber of the tool body. The plurality of first terminals correspond to a size of the first terminal die. The method further includes positioning an initial terminal of the plurality of first terminals proximate to the first terminal die. The method also includes actuating a ram from a retracted position to an extended position and crimping the initial terminal. Finally, the method includes advancing the plurality of first terminals so that a successive terminal is positioned proximate to the first terminal die. Returning the ram from the extended position to the retracted position can automatically advance the successive terminal.

The disclosure herein should become evident to a person of ordinary skill in the art given the following enabling description and drawings. The drawings are for illustration purposes only and are not drawn to scale unless otherwise indicated. The drawings are not intended to limit the scope of the example. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred forms and reference to the accompany drawing wherein:

FIG. 1 is a side view of a first example of a handheld power tool.

FIG. 2 is a first bottom detail view of a tool head of the handheld power tool of FIG. 1.

FIG. 3 is a second bottom detail view of a tool head of the handheld power tool of FIG. 1.

FIG. 4 is a top view of the tool head of the handheld power tool of FIG. 1.

FIG. 4-1 is a side view of the drive system of the handheld power tool of FIG. 1.

FIG. 4-2 is a schematic view of the terminals on a strip of material.

FIG. 5 is a perspective view of a housing of the handheld power tool of FIG. 1.

FIG. 6 is a side view of the housing of FIG. 5.

FIG. 7 is a front schematic view of the drive system of the handheld power tool of FIG. 1.

FIG. 8 is a side schematic view of the drive system of FIG. 7.

FIG. 9 is a top schematic view of a drive system of FIG. 7.

FIG. 10 is a side view of a second example of a handheld power tool.

FIG. 11 is a first bottom detail view of a tool head of the handheld power tool of FIG. 9.

FIG. 12 is a first bottom detail view of a tool head of the handheld power tool of FIG. 10.

FIG. 13 is a cross-sectional view of the handheld power tool of FIG. 10, illustrating a housing.

FIG. 14 is a perspective view of a third example of a handheld power tool.

FIG. 15 is a side view of the handheld power tool of FIG. 14.

FIG. 16 is a perspective view of a fourth example of a handheld power tool.

FIG. 17 is a first perspective view of a fifth example of a handheld power tool.

FIG. 18 is a second perspective view of the fifth example of a handheld power tool.

FIG. 19 is a front view of a spool usable with the fifth example of the handheld power tool.

FIG. 20 is a perspective view of a sixth example of a handheld power tool.

FIG. 21 is a side view of the handheld power tool of FIG. 20.

FIG. 22 is a detail view of a working area of the handheld power tool of FIG. 20.

FIG. 23 is a first alternate example of the handheld power tool of FIG. 20.

FIG. 24 is a second alternate example of the handheld power tool of FIG. 20.

FIG. 25 is a third alternate example of the handheld power tool of FIG. 20.

FIG. 26 is a fourth alternate example of the handheld power tool of FIG. 20.

FIG. 27 is a fifth alternate example of the handheld power tool of FIG. 20.

FIG. 28 is a side view of a seventh example of a handheld power tool.

FIG. 29 is a side view of an eighth example of a handheld power tool.

FIG. 30 is a side view of a ninth example of a handheld power tool.

FIG. 31 is a side view of a tenth example of a handheld power tool.

FIG. 32 is a perspective view of an eleventh example of a handheld power tool.

FIG. 33 is a side view of the handheld power tool of FIG. 32.

FIG. 34 is a side view of an alternate example of the handheld power tool of FIG. 32.

FIG. 35 is a side view of another alternate example of the handheld power tool of FIG. 32.

FIG. 36 is a top schematic view of a twelfth example of a handheld power tool.

FIG. 37 is a top schematic view of a crimp lever and die set of the handheld power tool of FIG. 36.

FIG. 38 is a top schematic view of a housing of the handheld power tool of FIG. 36.

FIG. 39 is a top schematic view of a crimp lever actuator of the handheld power tool of FIG. 36.

FIG. 40 is a side schematic view of a thirteenth example of a handheld power tool.

FIG. 41 is a schematic view of a drive system of the handheld power tool of FIG. 40.

FIG. 42 is a schematic view of a working portion of the handheld power tool of FIG. 40.

### DETAILED DESCRIPTION

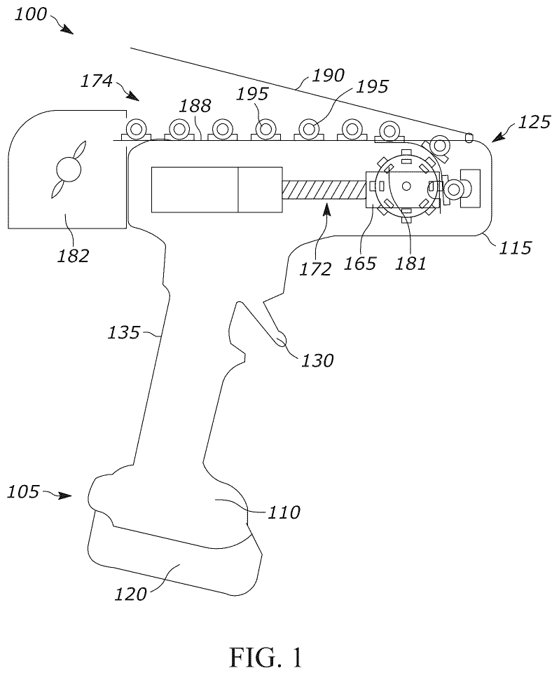

FIG. 1 illustrates a first example of a handheld power tool 100. The power tool 100 may specifically be a crimping tool, although it may be another kind of crimping tool without departing from the scope of the disclosure.

The power tool 100 may include a body 105 with a first end 110 and a second end 115. The first end 110 may include electrical contacts (not shown). A battery 120 (e.g., a power tool battery pack) may be connected to the electrical contacts at the first end 110. In the illustrated example, the battery 120 may be removable from the first end 110 and replaceable and/or rechargeable. In other examples, an electrical cord (not shown) may be disposed proximate to the first end to provide electrical power to the power tool 100.

In some forms, the power tool 100 may be a pistol-shaped power tool. For example, body 105 may extend in a first direction and a second direction whereby a common axis does not extend along the length of the body 105 between the first end 110 and the second end 115.

In some forms, the body 105 may be at least partially formed from an injection-molded material (e.g., plastic). In some forms, the body 105 may be at least partially constructed using additive manufacturing. In some forms, the body 105 may be machined. In other examples, one or more of these manufacturing methods may be used together.

The second end 115 may include tool head 125 which may be at least partially movable relative to the remainder of the body 105. As described in more detail below, the tool head 125 may be selectively operable to provide a crimping force.

In some forms, the body 105 may include an actuator 130 (e.g., a trigger). The actuator 130 may be disposed between the first and second ends 110, 115. The actuator 130 may be movable between a first position and a second position, which as described in more detail below, can selectively control the position of the tool head 125. In some forms, the actuator 130 may be a single-stage actuator. In other forms, the actuator 130 may be a multi-stage actuator (e.g., a two-stage actuator).

In certain examples, the body 105 may include a grasping portion 135 disposed proximate to the actuator 130. The body 105 may be held by a technician at the grasping portion 135 when the power tool 100 is in use. The grasping portion 135 may be a different material and/or texture to assist in permitting the technician to grip the body 105.

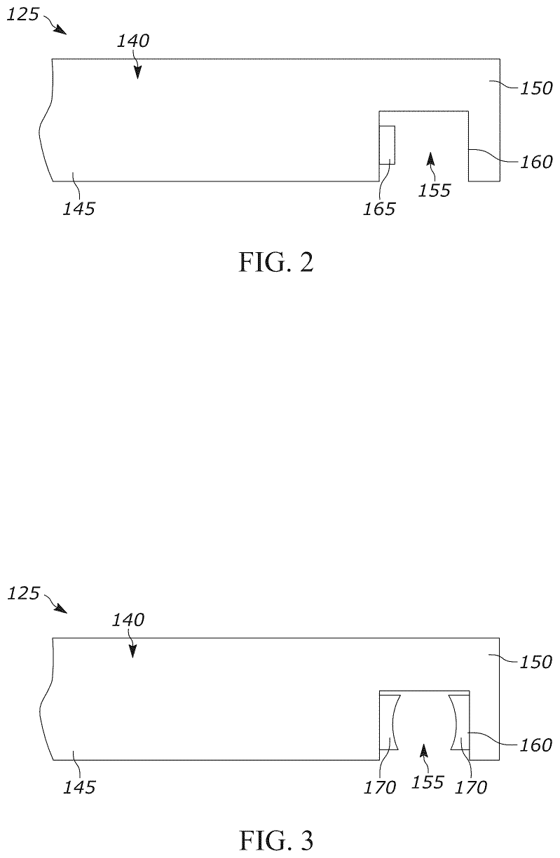

As shown in FIGS. 2 and 3, the tool head 125 may include a frame 140 formed from a substantially rigid material (e.g., metal, rigid plastic, etc.). The frame 140 may include a first end 145 coupled to the second end 115 of the body 105 and a second end 150 that is spaced apart from the first end 145. The illustrated frame 140 may include a substantially C-shaped structure with a space or working area 155 formed between the first and second ends 145, 150.

In certain forms, the C-shaped frame 140 may be oriented in a plane along the second direction. For example, the C-shaped frame 140 may be oriented in a substantially horizontal plane when the power tool 100 is resting on the battery pack (see e.g., FIG. 1). The C-shape may be oriented to that when the grasping portion 135 is held by a right-handed technician, the opening of the C-shape may be oriented toward a center of the technician's body. This may allow the technician to better see into the working area 155 while using the power tool 100.

In one form, the orientation of the C-shaped frame 140 may be adjustable. For example, a technician may rotate the frame 140 by 180 degrees so that it is oriented in the opposite direction on the same plane. This may be beneficial if a technician is left-handed.

In other forms, the frame 140 may have a different shape. For example, the frame 140 may include an enclosed perimeter surrounding the working area 155. The enclosed perimeter may have a circular shape, an elliptical shape, a rectangular shape, or any other similar shape.

In some forms, the second end 150 of the frame 140 may include a stop surface 160, which may be fixed relative to the remainder of the tool head 125. For example, shape of the frame 140 may be substantially fixed so that the position of the stop surface 160 is fixed relative to the first end 145.

In some forms, the power tool 100 may include a piston or ram 165 that extends from the second end 115 of the body 105. The frame 140 may be disposed around the second end 115 of the body 105 so that the ram 165 extends toward the second end 150 of the frame 140. More particularly, the ram 165 may extend from a retracted position to an extended position proximate to the stop surface 160.

As shown in FIG. 3, dies 170 may be connected to the frame 140. For example, a pair of dies 170 may be connected to the frame 140, with one proximate to the ram 165 and one proximate to the stop surface 160. Multiple pairs of dies 170 may be used with the power tool 100. For example, each pair of dies 170 may be different (e.g., a different size, a different shape, etc.) and may be used for specific purposes. As described in more detail below, different sized dies 170 may correspond to different sized terminals to be crimped. A technician may select an appropriate pair of dies 170 for a specific crimping operation and may replace the selected pair for a different pair of die 170 to perform a different operation (e.g., crimping a larger or smaller terminals).

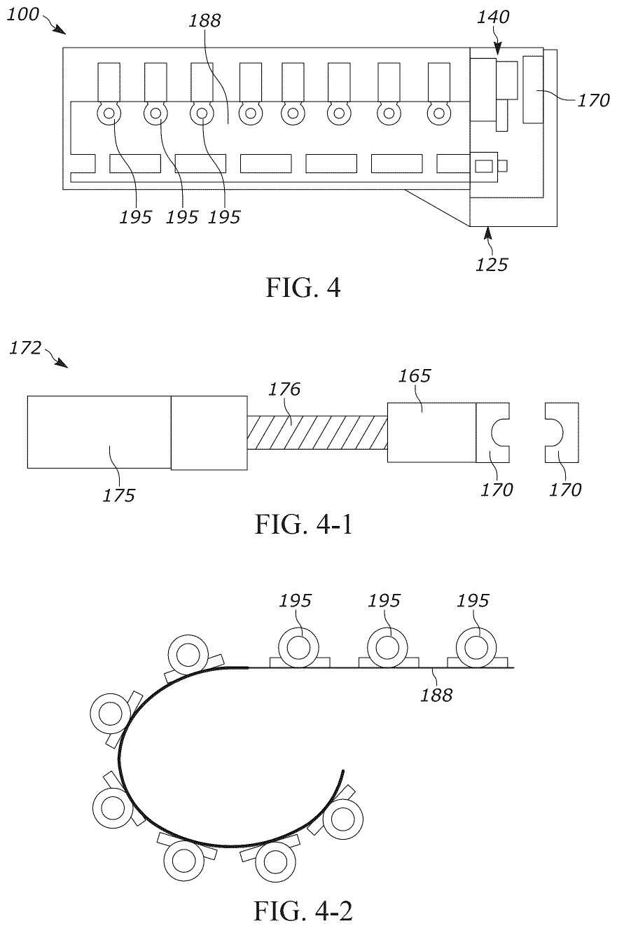

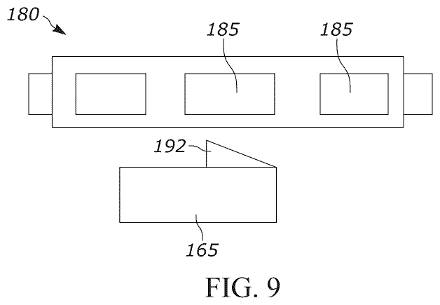

As shown in FIGS. 4-1 and 7 to 9, a drive system 172 may be disposed within a cavity 174 of the body 105. For example, the cavity 174 may be disposed proximate to the second end 115 of the body 105 and the tool head 125. In the illustrated example, the drive system 172 may include a sprocket 180, which may be disposed within a cavity 174. The drive system 172 may include a motor 175 and a drive shaft 176, which can drive the ram 165. In some examples, the drive system 172 may include a pair of sprockets 180 with a first sprocket 180 disposed proximate to the ram 165 and a second sprocket 180 disposed at a rear of the body 105. In other examples, the drive system 172 may include further sprockets 180 and/or may further include one or more rollers that may be disposed between the sprockets 180.

In certain forms, the drive system 172 may include a belt that is supported between the sprockets 180 and/or rollers. The belt may be driven to rotate with the rotation of the sprockets 180.

In certain forms, a spool 181 (see e.g., FIG. 1) may be disposed outside of the cavity 174. For example, the spool 181 may be at least partially contained with a housing 182 that can connect (e.g., clip) to the body 105. The housing 182 can include an internal space that permits the spool 181 to rotate. Other examples may include a sprocket 180 in place of the spool 181. As described in more detail below, the spool 181 may be removable from the housing 182 and/or replaceable with a different spool 181.

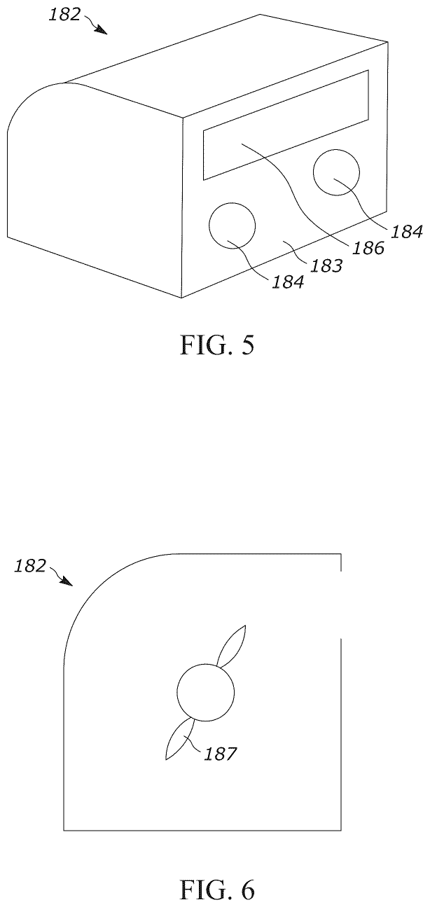

As shown in FIG. 5, the housing 182 may include a front surface 183 which may correspond to a rear surface of the body 105. For example, the body 105 and the front surface 183 may have a complementary profile so that they can engage one another.

In some forms, the front surface 183 may include connecting features 184, which can engage complementary connecting features on the body 105. Some forms of the connecting features 184 may be projections and/or grooves to form a mechanical connection with the body 105. In other examples, the connecting features 184 may be magnets.

In some forms, the front surface 183 may also include a slot 186, which may align with an opening of the cavity 174. As described in more detail below, the slot 186 may permit material to pass between the housing 182 and the cavity 174.

As shown in FIG. 6, a side surface of the housing 182 may include a control or reel 187. In the illustrated example, the reel 187 may be rotatable relative to an outer surface of the housing 182. The reel 187 may be connected to the spool 181 so that rotation of the reel 187 causes rotation of the spool 181.

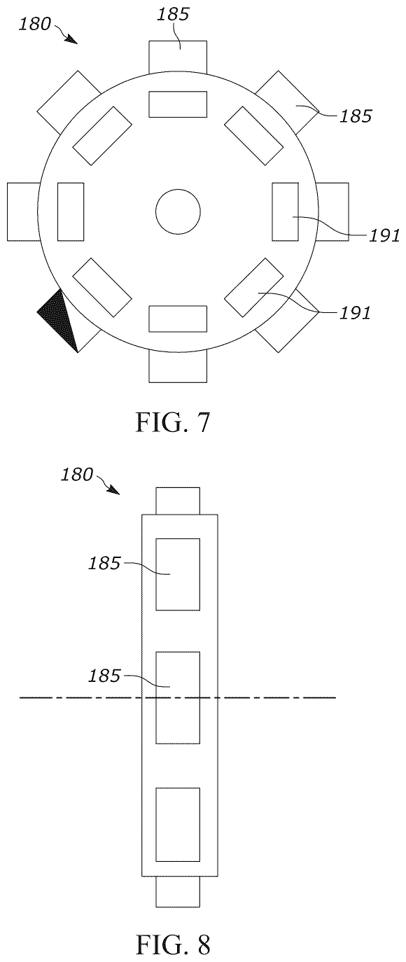

As shown in FIGS. 7 to 9, the sprocket 180 may be formed as a substantially cylindrical member with a plurality of teeth 185 that project from the cylindrical surface, although it may be other shapes in other examples. In the illustrated example, the teeth 185 may be substantially equally spaced around the outer perimeter of the sprocket 180. In examples with multiple sprockets, teeth 185 on the first sprocket 180 may be spaced at the same angular distance as the teeth 185 on the second sprocket 180 (although there may be different spacing in other examples).

In some forms, the sprocket 180 and the spool 181 may be positioned in line with one another and oriented to rotate around parallel axes. As described in more detail below, the sprocket 180 and the spool 181 may be configured to rotate along axes that are substantially perpendicular to the axis along which the ram 165 moves.

In some forms, the sprocket 180 may include a series of detents 191 spaced along a surface that is radially inside of the teeth 185. In the illustrated example, the detents 191 may be arranged proximate to the outer edge of the surface and may be equally spaced around the perimeter. In some examples, the detents 191 and the teeth 185 may have the same spacing. In other examples, the spacing between adjacent detents 191 may be more or less than the spacing between adjacent teeth 185.

Returning to FIG. 1, the body 105 may include a cover or door 190 that can selectively provide access to the cavity 174. For example, the cover 190 may be pivotably hinged to move between an opened and closed position. In the opened position, a technician may be able to access the cavity 174 (e.g., to load terminals for deployment as described in more detail below). In the closed position, access to the cavity 174 may be at least partially blocked. In some examples, the power tool 100 may only operate when the cover 190 is in the closed position (e.g., to limit unintended interference with the drive system 172). Additionally, a gap may exist at an end of the body 105 (e.g., distal to the frame 140) between the cover 190 and the cavity 174. In other words, the cover 190 may not fully block access to the cavity 174 in the closed position. The slot 186 may be disposed proximate to this gap to facilitate communication between the housing 182 and the cavity 174. As described in more detail below, the gap may permit terminals to enter the cavity during operation of the power tool 100.

In other examples, the cover 190 may be connected to the body 105 in a different way. For example, the cover 190 may be slidably connected, connected with a snap-fit, magnetically connected, or any other similar means of connection. These examples of the cover 190 may be similarly movable between an opened and closed position.

In some forms, material may be wrapped around the spool 181. For example, a mylar strip 188 (or other similar material) may be wrapped around the spool 181. Terminals 195 may be coupled to the strip of material 188. The spool 181 may come pre-wrapped with the strip of material 188 and the spool 181 may be removed and replaced when the material 188 is completely unwound. In other examples, after the first strip of material 188 is completely unwound, a technician can wind a new strip of material 188 around the spool 181.

In use, the technician may load the strip of material 188 and the attached terminals 195 into the cavity 174. For example, the technician may move the cover 190 to an open position to expose the cavity 174. The technician may pull the strip of material 188 so that it extends through the cavity 174 to the sprocket 180. The terminals 195 may be received in a space between the teeth 185 of the sprocket 180. Once the strip of material 188 is positioned within the cavity 174, the technician may return the cover 190 to the closed position. The technician may use the reel 187 to adjust the length of the material 188 and the position of the first terminal 195. In other words, the technician may rotate the reel 187 to unspool more material 188 or retract excess material 188 so that the first terminal 195 is properly positioned for the first crimping cycle. The gap between the cover 190 and the body 105 that provides access to the cavity 174 in the closed position may allows the strip of material 188 to feed into the cavity 174 (e.g., via the slot 186) when the cover 190 is closed.

As shown in FIGS. 1 and 4-2, the strip of material 188 may also extend beyond the sprocket 180. For example, the strip of material 188 (and associated terminals 195) may extend into the working area 155 where the dies 170 can contact and crimp the terminal 195.

The technician may engage the actuator 130, which drives the movement of the ram 165. For example, the ram 165 moves from the retracted position to the extended position. The movement of the ram 165 drives the movement of a first die 170 connected to the ram 165 toward a second die 170 coupled to the stop surface 160.

Conductors (e.g., wires) may be inserted into the terminal 195 prior to the ram 165 being advanced. The first terminal 195 may be disposed in the working area 155 between the first and second dies 170. As the ram 165 continues to advance, the dies 170 contact and crimp the first terminal 195. This secures the conductors within the terminal 195.

Once the crimping operation is complete, the technician may be alerted to release the actuator 130 causing the ram 165 to retract. As the ram 165 moves toward the retracted position, the sprocket 180 may be driven to rotate to advance the strip of material 188 to position a subsequent terminal 195 in the working area 155.

In some forms, ram 165 may include a projection 192 that engages the detent 191 of the sprocket 180 as ram 165 returns to the retracted position. Contact between the projection 192 and the detent 191 may cause the sprocket 180 to rotate. As the sprocket 180 rotates, the teeth 185 may contact the uncrimped terminals and cause the material 188 to advance through the cavity 174.

In some forms, the sprocket 180 may rotate a sufficient distance to the subsequent uncrimped terminal 195 to move into the working area 155. In other words, the next uncrimped terminal 195 may automatically move into the working area to be crimped and then the sprocket 180 will stop rotating.

In certain forms, the terminal 195 connected to the sheet of material 188 may determine the angular rotation of the sprocket 180. For example, the set of dies 170 may be sized to crimp one sized terminal 195. The selected dies 170 may be replaced with other sized dies 170 when different sized terminals 195 are disposed within the cavity 174. The different sized terminals 195 may be spaced apart different distances on the sheet of material 188, thus necessitating a different amount of movement to advance a subsequent terminal 195 to the working area 155.

In one form, a sensor may detect the size of the terminal and determine an angular distance that the sprocket 180 needs to rotate to advance the subsequent terminal 195. For example, the sensor may detect the specific die pair 170 that are connected to the body 105. In another example, a sensor (e.g., a photosensor) may be positioned in the cavity 174 and can measure spacing between the terminals 195 to determine the size of the terminal 195. In yet another example, a sensor may be contained in the housing 182 and can detect a specific spool 181 that is inserted. In yet another example, the body 105 may include an input device (e.g., a button, a screen, etc.) where the technician can enter the size of the terminal 195 currently used. A power tool 100 may include one or more of these examples or may include a similar type of sensor or input device without departing from the scope of the disclosure.

A controller may communicate with the sensor and may contain preprogrammed rotational settings for each type of terminal 195. For example, sensing a terminal 195 having a first size may correspond to rotating the sprocket 180 a first angular distance. Sensing a terminal 195 having a second size may correspond to rotating the sprocket 180 a second angular distance. When the sprocket 180 is rotated the preprogrammed angular distance, the subsequent terminal 195 will be automatically advanced so that the technician can engage the actuator 130 and crimp the successive terminal 195.

In other examples, the ram 165 and the sprocket 180 may be driven by different motors. For example, engaging the actuator 135 may cause a first motor to rotate, which in turn drives the ram 165 to move between the retracted and extended positions. In this example, movement of the sprocket 180 may not be driven by the retraction of the ram 165 (and therefore the first motor). Instead, the body 105 may include a sprocket actuator that can selectively drive a second motor that rotates the sprocket 180. In this example, the technician can selectively advance the subsequent terminal 195 a working area 155.

In one example, the sprocket 180 can be driven by both the retraction of the ram 165 or by the second motor. For example, the technician may use the sprocket actuator if the sensor misread the terminal currently inserted into the cavity 174.

Once the crimp is complete, a technician may remove the terminal 195 from the sheet of material 188. As the material 188 is advanced so that the subsequent terminal is disposed in the working area 155, the spent material may no longer be needed. In one form, the body 105 may include a slot where the spend material enters. Some examples may include a second spool where the material 188 is wound around. Other examples may include a receptacle where the material is stored until it is emptied by the technician (e.g., when all terminals 195 are crimped).

In other examples, the tool head 125 (or other part of the power tool 100) may include a serrated portion. After the crimped terminal 195 is removed, the technician may used the serrated portion to remove the excess material.

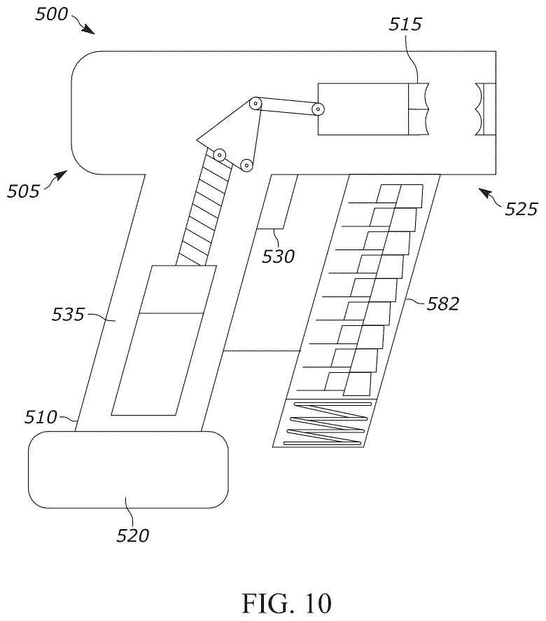

FIGS. 10 to 13 illustrate an alternate example of a power tool 500. The power tool 500 may be similar to the power tool 100 and only some similarities and differences may be described below. Similar features may include the same reference numbers plus “400”.

The power tool 500 may include a body 505 with a first end 510 and a second end 515. The first end 510 may include electrical contacts (not shown). A battery 520 (e.g., a power tool battery pack) may be connected to the electrical contacts at the first end 510. In the illustrated example, the battery 520 may be removable from the first end 510 and replaceable and/or rechargeable. In other examples, an electrical cord (not shown) may be disposed proximate to the first end to provide electrical power to the power tool 500. The power tool 500 may be a pistol-shaped power tool similar to the power tool 100. However, the power tool 500 may also be another shape.

In some forms, the body 505 may include an actuator 530 (e.g., a trigger). The actuator 530 may be disposed between the first and second ends 510, 515. The actuator 530 may be movable between a first position and a second position, which as described in more detail below, can selectively control the position of the tool head 525. In some forms, the actuator 530 may be a single-stage actuator. In other forms, the actuator 530 may be a multi-stage actuator (e.g., a two-stage actuator).

In certain examples, the body 505 may include a grasping portion 535 disposed proximate to the actuator 530. The body 505 may be held by a technician at the grasping portion 535 when the power tool 500 is in use. The grasping portion 535 may be a different material and/or texture to assist in permitting the technician to grip the body 505.

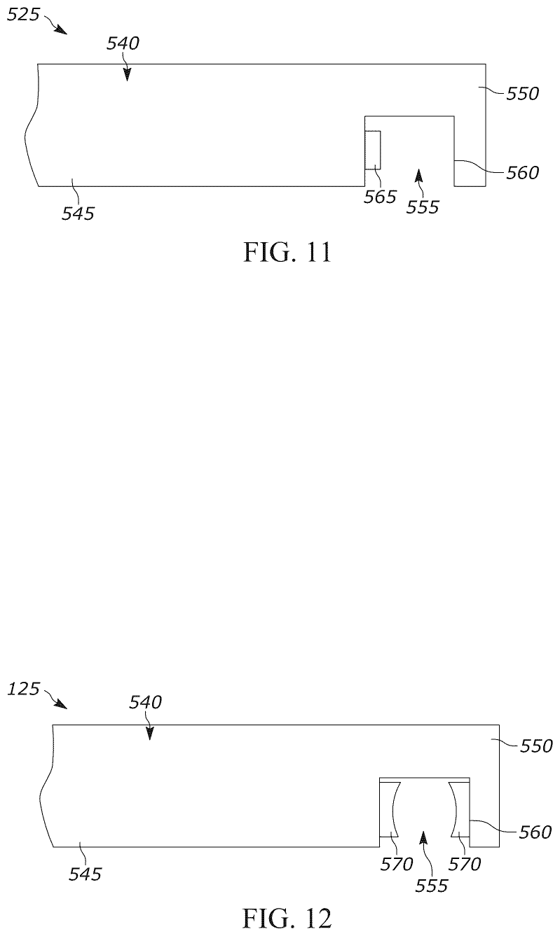

As shown in FIGS. 11 and 12, some forms of the power tool 500 may include a tool head 525 with a frame 540 formed from a substantially rigid material (e.g., metal, rigid plastic, etc.). The frame 540 may include a first end 545 coupled to the second end 515 of the body 505 and a second end 550 that is spaced apart from the first end 545. The illustrated frame 540 may include a substantially C-shaped structure with a space or working area 555 formed between the first and second ends 545, 550. As described with respect to the power tool 100, the C-shaped frame 540 of the power tool 500 may be oriented to provide ease of use for right-handed users. Other examples may include adjustable or alternatively shaped C-shaped frames 540 for left-handed users.

In some forms, the second end 550 of the frame 540 may include a stop surface 560, which may be fixed relative to the remainder of the tool head 525. For example, shape of the frame 540 may be substantially fixed so that the position of the stop surface 560 is fixed relative to the first end 545.

In some forms, the power tool 500 may include a piston or ram 565 that extends from the second end 515 of the body 505. The frame 540 may be disposed around the second end 515 of the body 505 so that the ram 565 extends toward the second end 550 of the frame 540. More particularly, the ram 565 may extend from a retracted position to an extended position proximate to the stop surface 560.

As shown in FIG. 12, dies 170 may be connected to the frame 540. For example, a pair of dies 170 may be connected to the frame 540, with one proximate to the ram 565 and one proximate to the stop surface 560. Multiple pairs of dies 170 may be used with the power tool 500. For example, each pair of dies 170 may be different (e.g., a different size, a different shape, etc.) and may be used for specific purposes. As described in more detail below, different sized dies 170 may correspond to different sized terminals to be crimped. A technician may select an appropriate pair of dies 170 for a specific crimping operation and may replace the selected pair for a different pair of die 170 to perform a different operation (e.g., crimping a larger or smaller terminals).

In some forms, the dies 170 used with the power tool 500 may be the same dies 170 used with the power tool 100. In other words, the connection between the dies 170 and the frame 540 may be the same as the connection between the dies 170 and the frame 140. This may permit the dies 170 to be used interchangeably with multiple types of power tools. In other examples, dies may be specific to a power tool 100, 500 and cannot be used interchangeably.

With continued reference to FIG. 10, a housing 582 may be coupled to an end of the body 505 proximate to the second end 515. For example, the housing 582 may extend in a direction substantially similar to the grasping portion 535. The housing 582 may be a magazine which can store uncrimped terminals 195 before they are crimped.

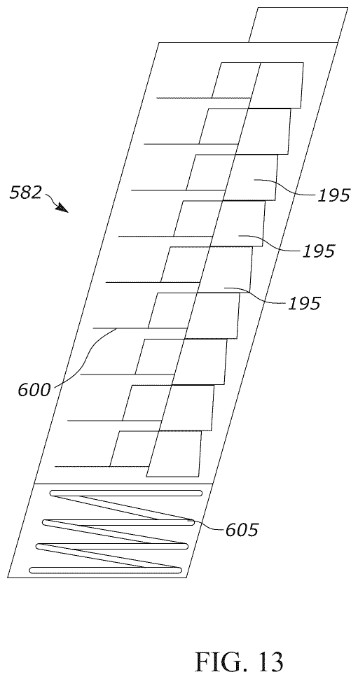

As shown in FIG. 13, the internal portion of the housing 582 may have a linear track 600 which can receive the uncrimped terminals 195. For example, the technician can load the terminals 195 into the housing 582 and they can be stored along the length of the housing 585. In some forms, a biasing member 605 (e.g., a spring) may be disposed at an end of the track 600. The biasing member 605 may be biased toward the opposite end of the track 600. A technician may have to insert the terminals 195 against the bias of the biasing member 605 to load the terminals 195.

In other examples, the power tool 500 may not include the housing 582. Instead, the body 505 may include a cavity with a cover (e.g., similar to cover 170) that is movable between an opened and closed position. A technician may move the cover to the open position and load uncrimped terminals 195. The cavity 574 may include a biasing member (e.g., a spring) that is biased toward the second end 515. The technician may load the terminals 195 against the bias of the biasing member. In this example, the uncrimped terminals 190 may be stored along a substantially perpendicular direction.

In either example, a biasing force may be strong enough to bias the first terminal toward the second end 515 of the power tool 500. The end of the housing 582 (or cavity) may be selectively closed until a terminal 195 is advanced to be crimped.

In use, the technician may engage the actuator 530, which causes the ram 565 to move toward the extended position. As described above, the dies 170 may come together and can crimp a terminal 195 in the working area 555. When the technician releases the actuator 530 and removes the crimped terminal 195, the ram 565 may return to the retracted position. In some forms this movement may cause the cavity to partially open and permit a successive terminal 195 to automatically move into the working area 555. The technician can then reengage the actuator 530 to begin the next crimping cycle. For example, the ram 565 may include a projection similar to projection 192 which can engage a detent at an end of the housing 582. This engagement may open the housing and allow a single terminal to exit the housing 582 into the working area 555 before the opening closes. The next terminal 195 can be crimped and the process can be repeated.

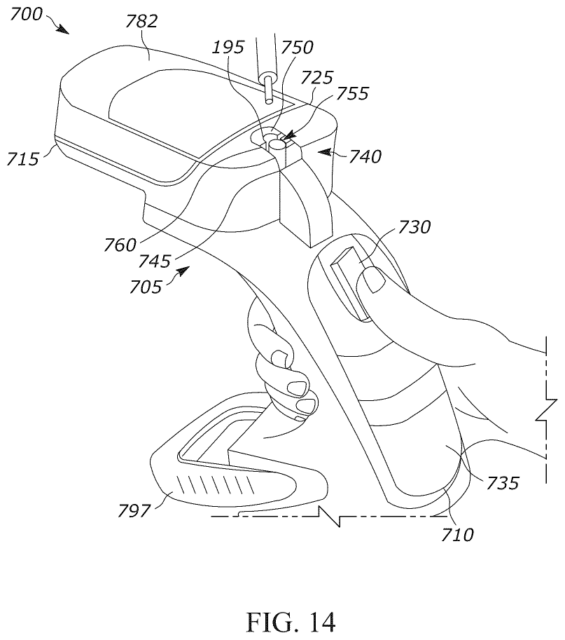

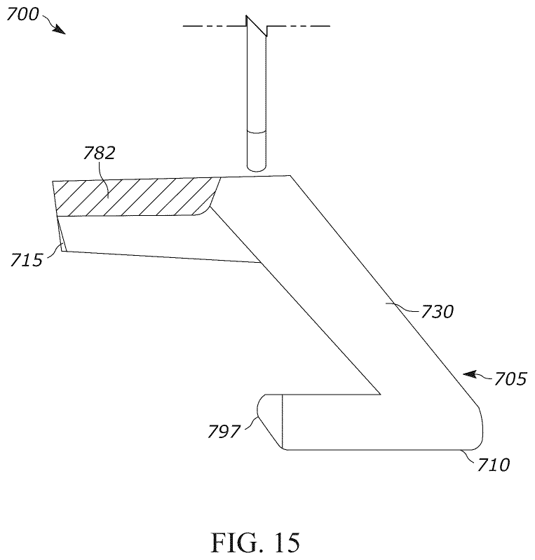

FIGS. 14 and 15 illustrate an alternate example of a power tool 700. The power tool 700 may be similar to the power tool 500 and only some similarities and differences may be described below. Similar features may include the same reference numbers plus “200”.

The power tool 700 may include a body 705 with a first end 710 and a second end 715. The first end 710 may include electrical contacts (not shown). A battery (e.g., a power tool battery pack) may be connected to the electrical contacts at the first end 710. In the illustrated example, the battery may be removable from the first end 710 and replaceable and/or rechargeable. In other examples, an electrical cord (not shown) may be disposed proximate to the first end to provide electrical power to the power tool 700. The power tool 700 may be a pistol-shaped power tool similar to the power tool 500. However, the power tool 700 may also be another shape.

In some forms, the body 705 may include an actuator 730 (e.g., a trigger). The actuator 730 may be disposed between the first and second ends 710, 715. The actuator 730 may be movable between a first position and a second position, which as described in more detail below, can selectively control the position of the tool head 725. In some forms, the actuator 730 may be a single-stage actuator. In other forms, the actuator 730 may be a multi-stage actuator (e.g., a two-stage actuator).

In certain examples, the body 705 may include a grasping portion 735 disposed proximate to the actuator 730. The body 705 may be held by a technician at the grasping portion 735 when the power tool 700 is in use. The grasping portion 735 may be a different material and/or texture to assist in permitting the technician to grip the body 705.

In some forms, the power tool 700 may include a tool head 725 with a frame 740 that may include a first end 745 and a second end 750 that is spaced apart from the first end 745. The frame 740 may include a substantially U-shaped structure with a space or working area 755 formed between the first and second ends 745, 750. The opening to the working area 755 may face upwardly (e.g., when the tool 700 is in use) to permit access from right or left-handed users.

In some forms, the second end 750 of the frame 740 may include a stop surface 760, which may be fixed relative to the remainder of the tool head 725. For example, shape of the frame 740 may be substantially fixed so that the position of the stop surface 760 is fixed relative to the first end 745.

In some forms, the power tool 700 may include a piston or ram that can be used to move the first end 745 toward the stop surface 760. The ram of the power tool 700 may be similar to the ram 565 extends toward the second end 750 of the frame 740. More particularly, the ram may extend from a retracted position to an extended position proximate to the stop surface 760.

In some forms, a housing 782 may be coupled to an end of the body 705 proximate to the second end 715. For example, the housing 782 may extend in a direction away from the second end 750 (e.g., along a direction of movement of the ram). The housing 782 may be a magazine which can store uncrimped terminals 795 before they are crimped.

In certain forms, the second end 715 may include a portion with a first width and a portion with a second width that is less than the first width. The first width may be formed proximate to the second end 750 and the portion with the second width may project away from the second end 750 as a free end of the tool 700. The housing 782 may removably connect to the body 705 along the portion of the second end 715 with the lesser width. The housing 782 may lockingly engage with the second end 715 during use of the tool 700.

The internal portion of the housing 782 may have a linear track, similar to the track 600 of the tool 500, which can receive the uncrimped terminals 195. For example, the technician can load the terminals 195 into the housing 782 and they can be stored within the housing 785 (e.g., along the length of the housing 782 and/or in a curved path). In some forms, a biasing member (e.g., a spring) may be disposed at an end of the track. A technician may have to insert the terminals 195 against the bias of the biasing member to load the terminals 195.

A biasing force may be strong enough to bias the first terminal toward the second end 715 of the power tool 700. The end of the housing 782 (or cavity) may be selectively closed until a terminal 195 is advanced to be crimped.

In use, the technician may engage the actuator 730, which causes the ram to move toward the extended position. Dies may come together and can crimp a terminal 195 in the working area 755. When the technician releases the actuator 730 and removes the crimped terminal 195, the ram may return to the retracted position. In some forms this movement may cause the cavity to partially open and permit a successive terminal 195 to automatically move into the working area 755. The technician can then reengage the actuator 730 to begin the next crimping cycle. For example, the ram may include a projection similar to projection 192 which can engage a detent at an end of the housing 782. This engagement may open the housing and allow a single terminal to exit the housing 782 into the working area 755 before the opening closes. The next terminal 195 can be crimped and the process can be repeated.

As shown in FIGS. 14 and 15, the terminal 195 may be oriented along the vertical direction when it is positioned within the working area 755. The technician may move an electrical conductor in a vertical direction to be received within the terminal 195 prior to engaging the actuator 730. This may allow technicians of either handedness to easily perform the crimping operation.

With continued reference to FIGS. 14 and 15, the first end 710 of the tool 700 may include a support 797, which may permit the technician to rest the tool 700 on a surface. For example, the support 797 may rest on a tabletop, a workbench, or other similar surface while the technician is using the tool 700 to limit movement of the tool 700. In the illustrated example, the support 797 may be adjustable to move between an extended and retracted position. The technician may adjust the position of the support 797 based on a distance between the tool 700 and the support surface.

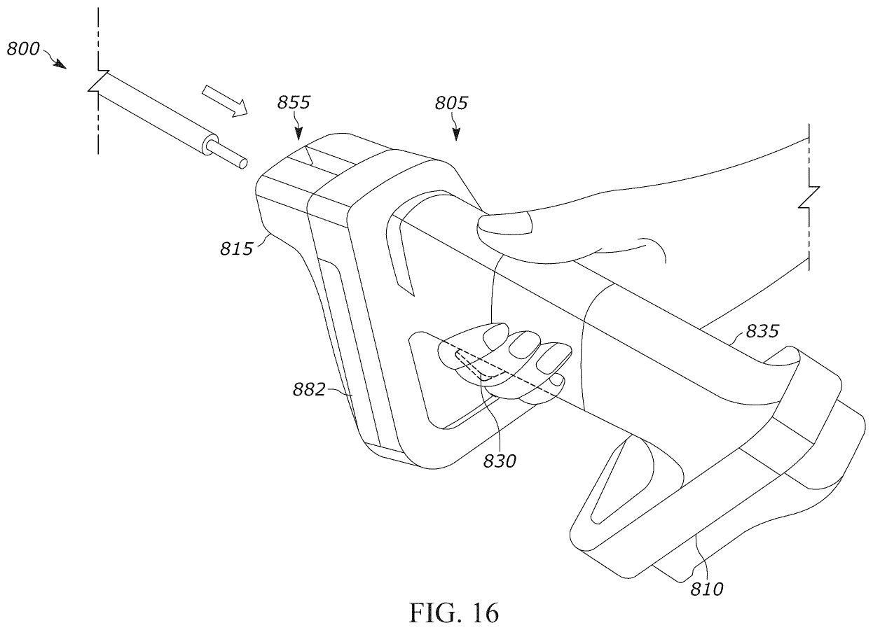

FIG. 16 illustrate an alternate example of a power tool 800. The power tool 800 may be similar to the power tool 700 and only some similarities and differences may be described below. Similar features may include the same reference numbers plus “100”.

In some forms, the power tool 800 may include a housing 882 connected to the body 805, which may be a magazine. The power tool 800 may similarly feed successive terminals into a working area 855, which may be shaped similar to the power tool 700. However, the working area 855 of the power tool 800 may be oriented along an axis that extends along the grasping portion 835. The electrical connector may be fed into the working portion along the axis and into the terminal to be crimped. The configuration of the tool 800 may permit a horizontal in-use position as opposed to a vertical in-use position of the tool 700.

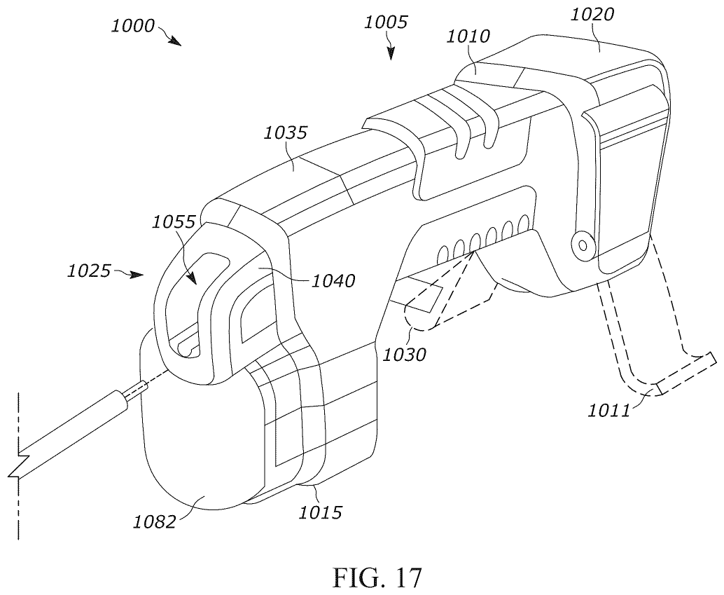

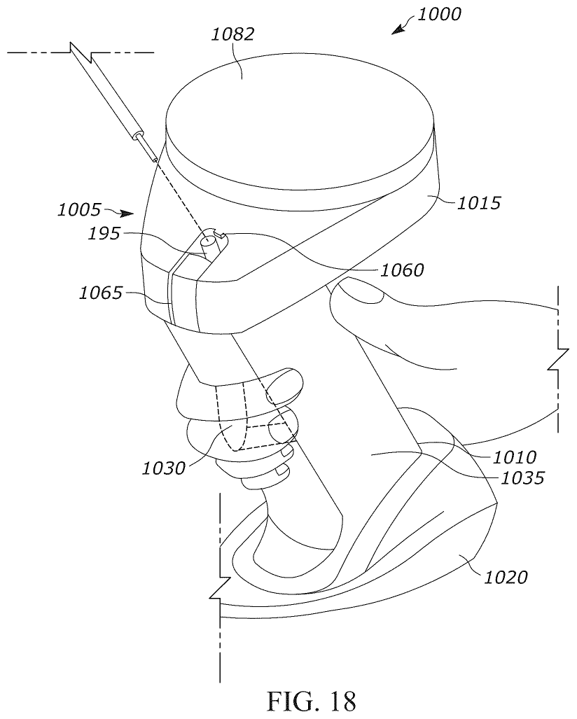

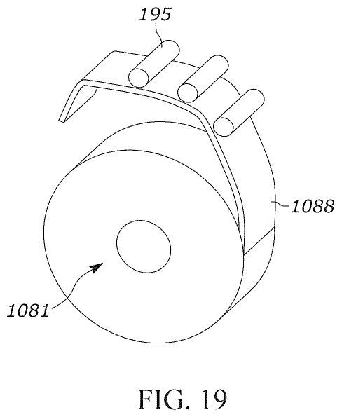

FIGS. 17 and 18 illustrate an alternate example of a power tool 1000, which may include a reel similar to the power tool 100. The power tool 1000 may include a body 1005 with a first end 1010 and a second end 1015. The first end 1010 may include electrical contacts (not shown). A battery 1020 (e.g., a power tool battery pack) may be connected to the electrical contacts at the first end 1010. In the illustrated example, the battery 1020 may be removable from the first end 1010 and replaceable and/or rechargeable. In other examples, an electrical cord (not shown) may be disposed proximate to the first end to provide electrical power to the power tool 1000.

In some forms, the body 1005 may be at least partially formed from an injection-molded material (e.g., plastic). In some forms, the body 1005 may be at least partially constructed using additive manufacturing. In some forms, the body 1005 may be machined. In other examples, one or more of these manufacturing methods may be used together.

In some forms, the body 1005 may include an actuator 1030 (e.g., a trigger). The actuator 1030 may be disposed between the first and second ends 1010, 1015. The actuator 1030 may be movable between a first position and a second position, which as described in more detail below, can selectively control the position of the tool head 1025. In some forms, the actuator 1030 may be a single-stage actuator. In other forms, the actuator 1030 may be a multi-stage actuator (e.g., a two-stage actuator). The actuator 1030 may be disposed on different sides of the body 1005 in different examples of the power tool 1000. For example, FIG. 17 illustrates the actuator 1030 on an underside of the body 1005 and FIG. 18 illustrates the actuator 1030 on a top of the body 1005. The different positions of the actuator 1030 may permit usage of the power tool 1000 in different orientations (e.g., because different users may find different orientations more comfortable).

In certain examples, the body 1005 may include a grasping portion 1035 disposed proximate to the actuator 1030. The body 1005 may be held by a technician at the grasping portion 1035 when the power tool 1000 is in use. The grasping portion 1035 may be a different material and/or texture to assist in permitting the technician to grip the body 1005.

The tool head 1025 may include a frame 1040 with a working area 1055. The frame 1040 may include a stop surface 1060, which may be fixed relative to the remainder of the tool head 1025. For example, the shape of the frame 1040 may be substantially fixed so that the position of the stop surface 1060 is fixed relative to the first end 1045. As shown in FIG. 18, the power tool 1000 may include a piston or ram 1065 that extends from the second end 1015 of the body 1005. The frame 1040 may be disposed around the second end 1015 of the body 1005 so that the ram 1065 extends toward the second end 1050 of the frame 1040. More particularly, the ram 1065 may extend from a retracted position to an extended position proximate to the stop surface 1060.

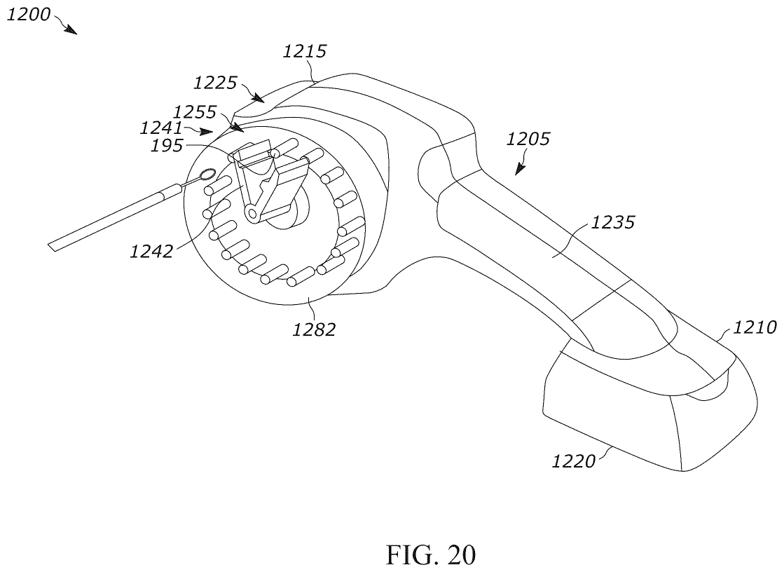

In some forms, the power tool 1000 may include a housing 1082 connectable to a surface of the body 1005. The housing 1082 may include a spool 1081 (see e.g., FIG. 19) that is rotatable within a cavity of the housing 1082. A drive system (similar to drive system 172) may be disposed within a portion of the body 1005, which may include a sprocket and a belt supported by the sprocket (e.g., similar to sprocket 180).

In some forms, the housing 1082 may form a substantially circular area to receive the spool 1081. The housing 1082 may also be disposed directly proximate to the working area 1055 (e.g., below the working area 1055 proximate to the second end 1015 as viewed in FIG. 17), although the housing 1082 mat be disposed in other locations in other examples of the power tool 1000.

As shown in FIG. 19, material may be wrapped around the spool 1081. For example, a mylar strip 1088 (or other similar material) may be wrapped around the spool 1081. Terminals 1095 may be coupled to the strip of material 1088. The spool 1081 may come pre-wrapped with the strip of material 1088 and the spool 1081 may be removed and replaced when the material 1088 is completely unwound. In other examples, after the first strip of material 1088 is completely unwound, a technician can wind a new strip of material 1088 around the spool 1081.

In use, the technician may load the strip of material 1088 and the attached terminals 1095 into the cavity. The technician may pull the strip of material 1088 so that it extends to the sprocket. The terminals 195 may be received in a space between the teeth of the sprocket. An end of the material 1088 may extend directly into the working area 1055 because the housing 1082 is disposed proximate to the second end 1015.

The technician may engage the actuator 1030, which drives the movement of a ram. Conductors (e.g., wires) may be inserted into the terminal 195 prior to the ram being advanced. The first terminal 195 may be disposed in the working area 1055 between first and second dies, which may contact and crimp the first terminal 195 as the ram advances thereby securing the conductor within the terminal. The technician may then release the actuator to retract the ram. As described above, the retracting ram may cause the drive system to advance the spool 1081 so that the next terminal 1095 moves into the working area 1055.

Once the crimp is complete, a technician may remove the terminal 195 from the sheet of material 1088. As the material 1088 is advanced so that the subsequent terminal is disposed in the working area 1055, the spent material may no longer be needed and can be removed (e.g., using any of the above-described methods) from the mylar strip 1088.

As shown in FIG. 17, some examples of the body 1005 may include a stand or support 1011 disposed proximate to the first end 1010. The support 1011 may be pivotably movable relative to the first end 1010 to selectively engage a support surface. This may permit the technician to at least partially support the power tool 1000 via the support 1011 while in use.

FIGS. 20 to 22 illustrate a sixth example of a handheld power tool 1200 (e.g., a crimping tool), which may be similar to any one of the above-described power tools. The power tool 1200 may include a body 1205 with a first end 1210 and a second end 1215, which may be arranged in a substantially linear manner. However, other examples may have a different shape. For example, the power tool 1200 in FIG. 24 may have a pistol shape where an axis that extends along the body 1205 does not intersect the first end 1210 and the second end 1215.

The first end 1210 may include electrical contacts (not shown). A battery 1220 (e.g., a power tool battery pack) may be connected to the electrical contacts at the first end 1210. In the illustrated example, the battery 1220 may be removable from the first end 1210 and replaceable and/or rechargeable. In other examples, an electrical cord (not shown) may be disposed proximate to the first end to provide electrical power to the power tool 1200.

In some forms, the body 1205 may be at least partially formed from an injection-molded material (e.g., plastic). In some forms, the body 1205 may be at least partially constructed using additive manufacturing. In some forms, the body 1205 may be machined. In other examples, one or more of these manufacturing methods may be used together.

The second end 1215 may include tool head 1225 which may be at least partially movable relative to the remainder of the body 1205. As described in more detail below, the tool head 1225 may be selectively operable to provide a crimping force.

In certain examples, the body 1205 may include a grasping portion 1235 disposed proximate to a trigger or actuator. The body 1205 may be held by a technician at the grasping portion 1235 when the power tool 100 is in use. The grasping portion 1235 may be a different material and/or texture to assist in permitting the technician to grip the body 1205.

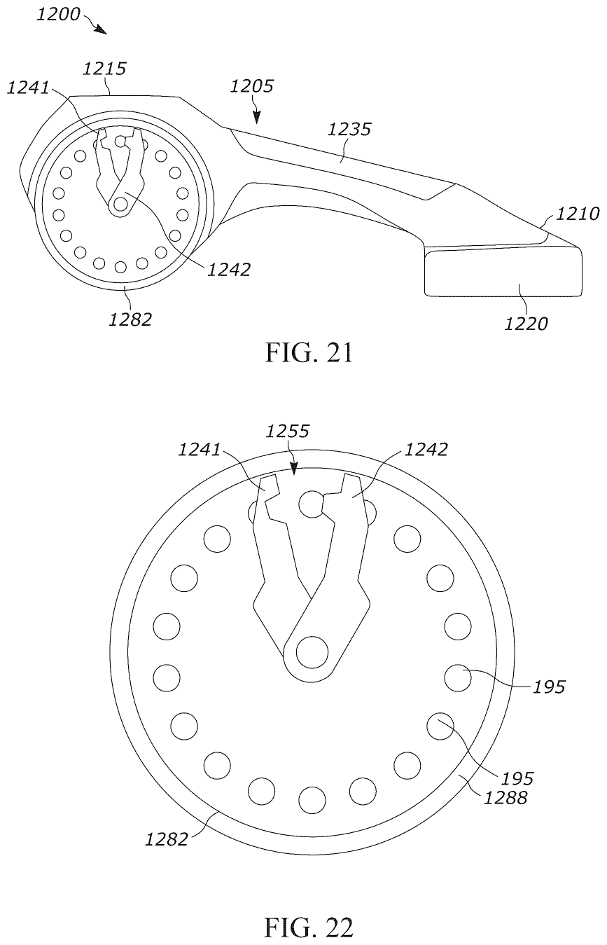

As shown in FIGS. 20 and 21, the tool head 1225 may include a frame 1240 formed from a substantially rigid material (e.g., metal, rigid plastic, etc.). The illustrated frame 1240 may include a space or working area 1255 that may be formed between a pair of movably jaws 1241, 1242. Dies may be connected to the movable jaws 1241, 1242 to correspond to different-sized terminals.

In some forms, a drive system may be disposed within the body 1205. Although not illustrated, the drive system of the power tool 1200 may be similar to any of the above-described drive systems (e.g., include a sprocket). The drive system may drive a spool that is located within the housing 1282, which may be disposed proximate to the second end 1215. Material may be wrapped around the spool. For example, a mylar strip (or other similar material) may be wrapped around the spool. Terminals 195 may be coupled to the strip of material. The spool may come pre-wrapped with the strip of material and the spool may be removed and replaced when the material is completely unwound. In other examples, after the first strip of material is completely unwound, a technician can wind a new strip of material around the spool.

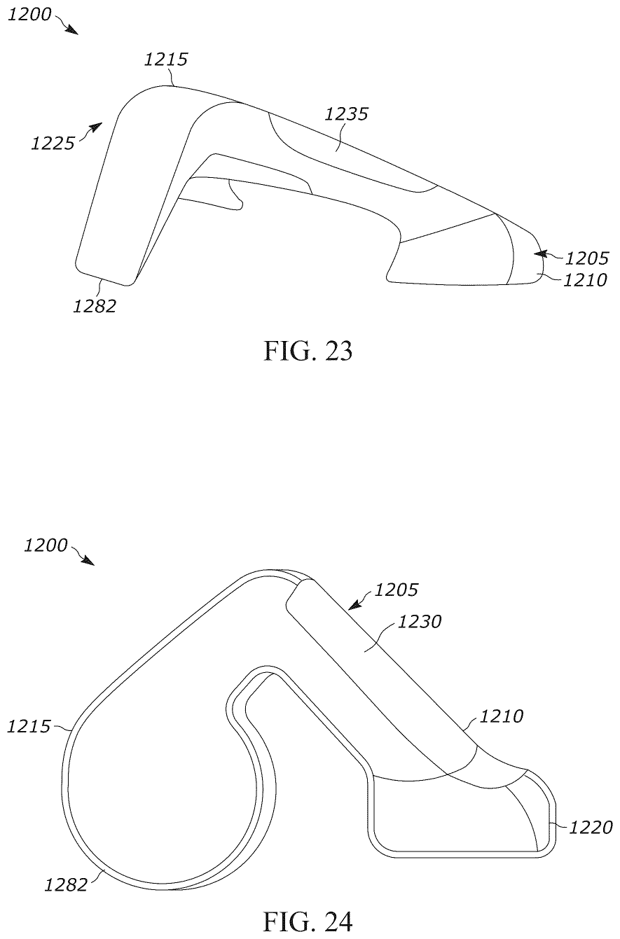

As shown in FIGS. 20 and 21, the housing 1282 may be located along a side of the body 1205. For example, the housing 1282 may be offset from an axis that extends along the body 1205 between the first and second ends 1210, 1215. In the illustrated example, the housing 1282 may be offset to a left side of the body 1205 to permit a technician to grasp the tool 1200 with their right hand. However, other examples may include the housing 1282 on the opposite side of the body 1205. As shown in FIG. 23, still other examples may include the housing 1282 on a front of the body 1205 (e.g., so that it intersects with the axis).

In use, the technician may load the strip of material and the attached terminals 195 into the cavity. Once the strip of material is positioned within the cavity, the technician may adjust the length of the material 1288 and the position of the first terminal 195 so that the first terminal 195 is properly positioned for the first crimping cycle (e.g., between the jaws 1241, 1242). Conductors (e.g., wires) may be inserted into the terminal 195 prior to the jaws 1241, 1242 being moved. The first terminal 195 may be disposed in the working area 1255 between jaws 1241, 1242, which contact and crimp the first terminal 195 (see e.g., FIG. 22). This secures the conductors within the terminal 195. The technician may release the actuator and allow the jaws 1241, 1242 to return to their initial position. Movement of the jaws 1241, 1242 toward their initial position may advance the spool so that the next terminal 195 moves into the working area 1255. As shown in FIG. 23, the hub within the housing 1282 containing the terminals 195 may rotate so that the next terminal is automatically moved into the working area 1255 between the open jaws 1241, 1242 (e.g., to awhile the subsequent crimp cycle).

As shown in FIG. 21, the housing 1282 may be sized so that it contacts the support surface during use of the power tool 1200. For example, the housing 1282 may be sized so that the battery 1220 and the housing 1282 contact the support surface in use. This may permit the technician to balance or support the power tool 1200 with two points of contact while using the power tool 1200. The alternate orientations illustrated in FIGS. 23 and 24 may similarly permit this.

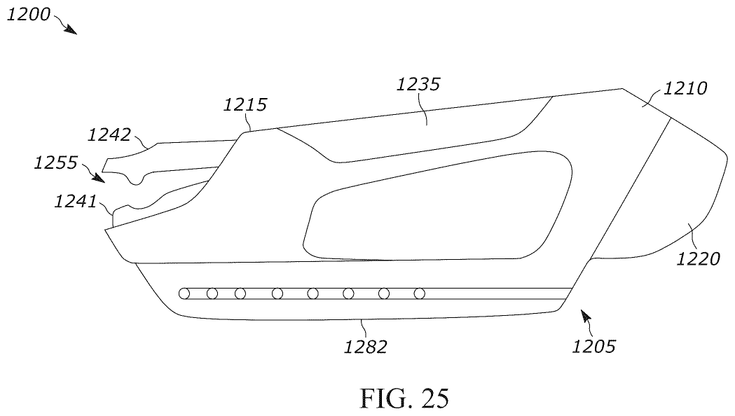

FIG. 25 illustrates an alternate example of the power tool 1200. This example may include an elongated track or internal cavity similar to cavity 174. The strip of material containing the terminals 195 may extend along the cavity to reach the movable jaws 1241, 1242 (e.g., each successive terminal 195 is automatically positioned within the working area 1255 between the opened jaws 1241, 1242). In this example, the jaws 1241, 1242 may rotate about a similarly directed axis as the jaws 1241, 1242 in FIGS. 20 to 22, but the jaws 1241, 1242 may have a different orientation (e.g., rotated about 90 degrees counterclockwise as viewed in FIGS. 23 and 25). Additionally, the jaws 1241, 1242 may be disposed at a first end 1210 of the body 1205.

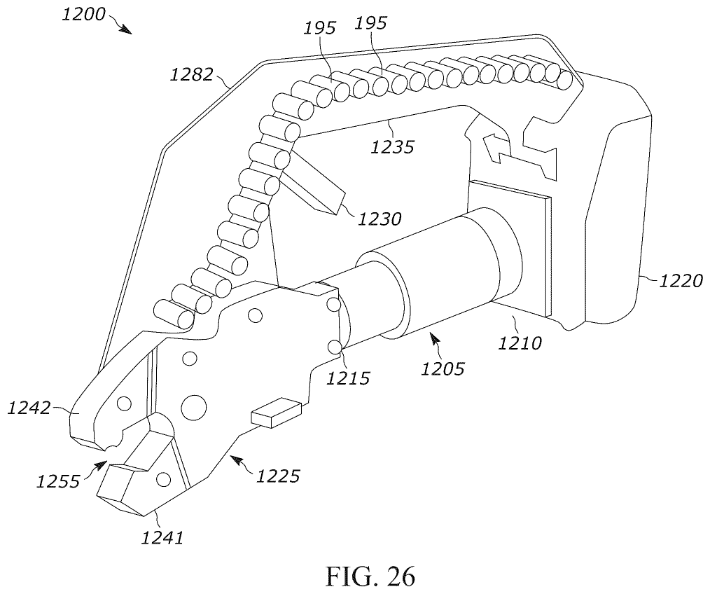

FIG. 26 illustrates an alternate example of the power tool 1200. This example may be similar to the example in FIG. 25, but may include a different position of the housing 1282. For example, the housing 1282 may be positioned on an upper end of the tool 1200 and the grasping portion 1235 may at least partially surround the housing 1282. In the illustrated example, the housing 1282 may extend above the jaws 1241, 1242 and may provide an opening behind the upper jaw 1242. The terminals 195 may be fed in a downwardly direction into the working area 1255 between the jaws 1241, 1242 to be crimped.

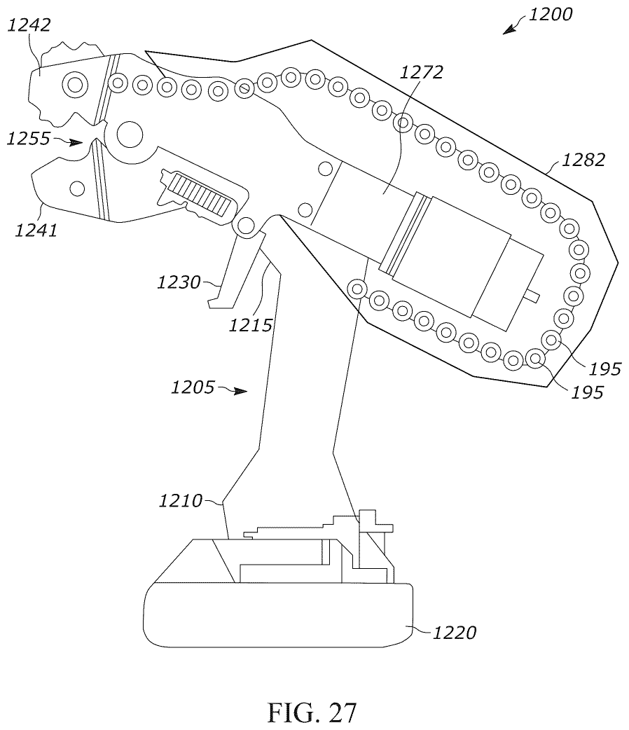

FIG. 27 illustrates a further alternate example of the power tool 1200, which may take the form of a pistol-style tool, similar to any of the above-described pistol tools. In this example, the housing 1282 may be disposed in the upper end 1215 of the body 1205. For example, the terminals 195 may extend along a track or path around the drive system 1272. The housing 1282 may include an opening proximate to the upper jaw 1242. The terminals 195 may be fed in a downwardly direction into the working area 1255 between the jaws 1241, 1242 to be crimped.

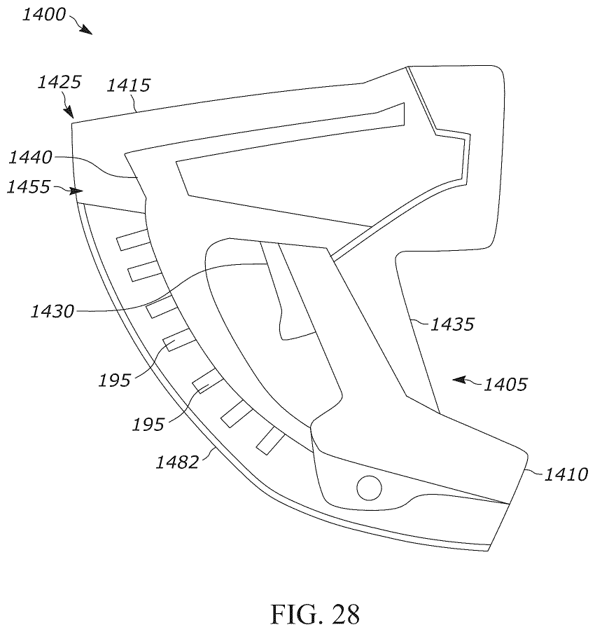

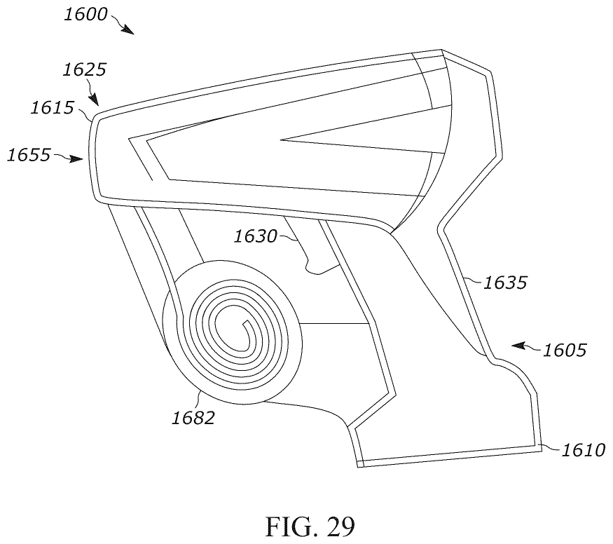

FIGS. 28 and 29 illustrate further alternate pistol-style examples of a power tool. The power tool 1400 of FIG. 28 and the power tool 1600 of FIG. 29 may be similar to one another and only some similarities and differences may be described below.

Each power tool 1400, 1600 may include a body 1405, 1605 (e.g., constructed from an injection molded material) with a first end 1410, 1610 and a second end 1415, 1615 respectively. The first end 1010 may include electrical contacts (not shown). A battery (e.g., a power tool battery pack) may be connected to the electrical contacts at the first end 1410, 1610. In the illustrated example, the battery may be removable from the first end 1410, 1610 and replaceable and/or rechargeable. In other examples, an electrical cord (not shown) may be disposed proximate to the first end to provide electrical power either example of the power tool 1400, 1600.

In some forms, the body 1405, 1605 may include an actuator 1430, 1630 (e.g., a trigger). The actuator 1430, 1630 may be disposed between the first end 1410, 1610 and the second end 1415, 1615. The actuator 1430, 1630 may be movable between a first position and a second position, which as described in more detail below, can selectively control the position of the tool head 1425, 1625. In some forms, the actuator 1430, 1630 may be a single-stage actuator. In other forms, the actuator 1430, 1630 may be a multi-stage actuator (e.g., a two-stage actuator).

In certain examples, the body 1405, 1605 may include a grasping portion 1435, 1635 disposed proximate to the actuator 1430, 1630. The body 1405, 1605 may be held by a technician at the grasping portion 1435, 1635 when the power tool 1400, 1600 is in use. The grasping portion 1435, 1635 may be a different material and/or texture to assist in permitting the technician to grip the body 1405, 1605.

The tool head 1425, 1625 may include a frame 1440, 1640 with a working area 1455, 1655. The frame 1440, 1640 may include a stop surface 1460, 1660, which may be fixed relative to the remainder of the tool head 1425, 1625. For example, the shape of the frame 1440, 1640 may be substantially fixed. The tool heads 1425, 1625 may include a ram or jaws similar to what is described above in the other examples.

In some forms, the power tool 1400, 1600 may include a housing 1482, 1682 connectable to a surface of the body 1405, 1605. The housing 1482 may enclose a channel that contains a track and the housing 1682 may include a spool that is rotatable within a cavity. Both examples may include a drive system (similar to drive system 172) that may be used to automatically drive terminals 195 toward the working area 1455, 1655 to be crimped.

In some forms, the housing 1482 of the power tool 1400 may be an elongated portion that at least partially encloses a channel that permits the terminals to move at least partially along the length of the body as the terminals move toward the working area 1455. In some forms, the housing 1682 may form a substantially circular area to receive the spool (e.g., with a mylar stripped wrapped around the spool). The housing 1682 may also be disposed proximate to the working area 1655 (e.g., below the working area 1655 and partially spaced from the working area 1655). The body 1605 may also include a channel between the housing 1682 and the working area 1655.

In certain forms, the housing 1482 may be similar to the door 190 in power tool 100. The housing 1482 may extend between the tool head 1425 and the first end 1410 along a path spaced apart from the grasping portion 1435, which may form a closed perimeter where the actuator 1430 is positioned. As described in more detail below, terminals 1495 may extend along this path to reach the tool head 1425.

In certain forms, the housing 1682 may have a similar shape as the housing 1482 and may extend between the first end 1610 and the tool head 1625. However, a portion of the housing 1682 may be larger to accommodate the spool. For example, this region with the larger width may be disposed between the first end 1610 and the tool head 1625.

The technician may engage the actuator 1430, 1630, which drives the movement of a ram and/or jaws. Conductors (e.g., wires) may be inserted into the terminal 195 prior to the ram being advanced (or the jaws being closed). The first terminal 195 may be disposed in the working area 1455, 1655 between first and second dies, which may contact and crimp the first terminal 195 as the ram (or jaws) advances thereby securing the conductor within the terminal. The technician may then release the actuator to retract the ram (or jaws), which may cause the drive system to advance the spool so that the next terminal 195 moves into the respective working area 1455, 1655.

Once the crimp is complete, a technician may remove the terminal 145 from the sheet of material. As the material is advanced so that the subsequent terminal is disposed in the working area 1455, 1655, the spent material may no longer be needed and can be removed (e.g., using any of the above-described methods) from the mylar strip.

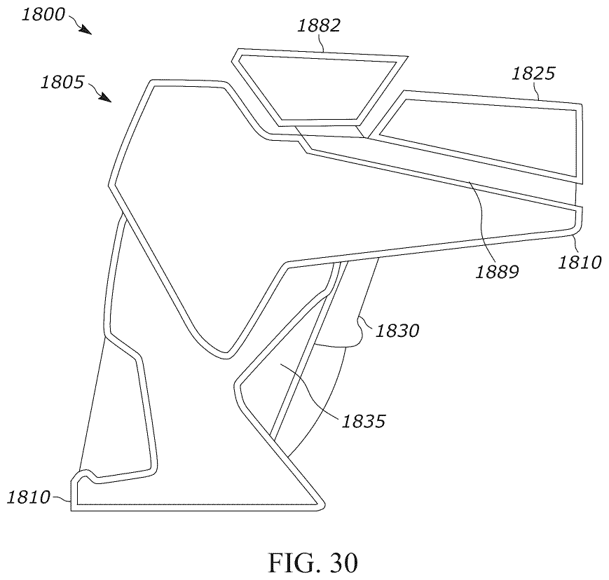

FIG. 30 illustrates an alternate example of a power tool 1800, which may include a body 1805 (e.g., formed from an injection-molded material) with a first end 1810 and a second end 1815. The power tool 1800 may be a pistol-style tool where an axis that extends along the body 1805 dies not intersect The first end 1810 may include electrical contacts (not shown). A battery (e.g., a power tool battery pack) may be connected to the electrical contacts at the first end 1810. In other examples, an electrical cord (not shown) may be disposed proximate to the first end to provide electrical power to the power tool 1800.

In some forms, the body 1805 may include an actuator 1830 (e.g., a trigger). The actuator 1830 may be disposed between the first and second ends 1810, 1815. The actuator 1830 may be movable between a first position and a second position, which as described in more detail below, can selectively control the position of the tool head 1825. In some forms, the actuator 1830 may be a single-stage actuator. In other forms, the actuator 1830 may be a multi-stage actuator (e.g., a two-stage actuator).

In certain examples, the body 1805 may include a grasping portion 1835 disposed proximate to the actuator 1830. The body 1805 may be held by a technician at the grasping portion 1835 when the power tool 1800 is in use. The grasping portion 1835 may be a different material and/or texture to assist in permitting the technician to grip the body 1805.

The tool head 1825 may include a frame with a working area (not shown). As described in more detail below, the working area may include a ram or jaws from crimping a terminal.

In some forms, the power tool 1800 may include a housing 1882 connectable to a surface of the body 1805. The housing 1882 may include an internal space that may house terminals. In the illustrated example, the terminals 195 may be disposed within the internal space of the housing 1882 with being disposed on a strip of material. A technician may disconnect the housing 1882 from the body 1805 and load individual terminals 195 into the housing 1882 before reconnecting the housing 1882 back to the body 1805.

When connected to the body 1805, the housing 1882 may be positioned proximate to and in communication with a channel 1889 that extends toward the second end 1815. The terminals 195 within the housing 1882 may be positioned to exit the housing 1882 and enter the channel 1889. A drive system (e.g., similar to any of the above-described systems) may move the terminals 195 along the channel 1889 until each terminal 195 reaches the second end 1815 and is crimped in the crimping operation.

The technician may engage the actuator 1830, which drives the movement of a ram and/or jaws. Conductors (e.g., wires) may be inserted into the terminal 195 prior to the ram being advanced (or the jaws being closed). The first terminal 195 may be disposed in the working area between first and second dies, which may contact and crimp the first terminal 195 as the ram (or jaws) advances thereby securing the conductor within the terminal. The technician may then release the actuator to retract the ram (or jaws), which may cause the drive system to advance the spool so that the next terminal 195 moves into the respective working area.

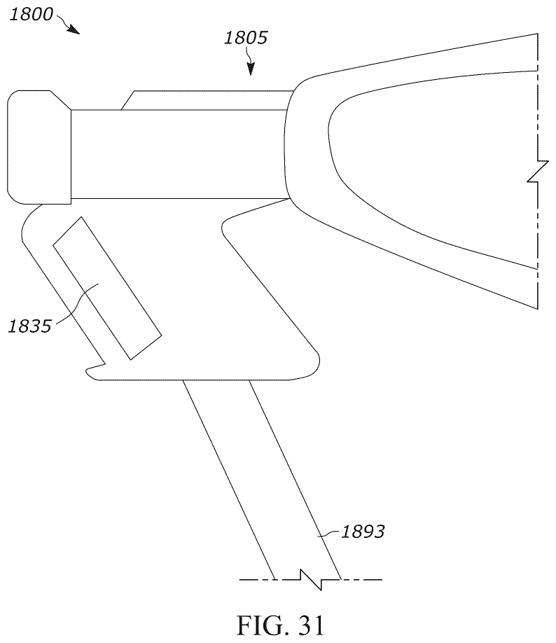

FIG. 31 illustrates an alternate example of the power tool 1800. In this example, the housing 1882 may be replaced with a magazine 1893. In the illustrated example, the magazine 1893 may be connected to an underside of the body 1805 and extend into the channel (e.g., similar to channel 1889). As described above, the magazine 1893 may be biased (e.g., with a spring) so that the terminals are urged toward the channel and toward the working area. In other examples, the body 1805 may not include a channel and the magazine 1893 may connect to the body 1805 proximate to the working area.

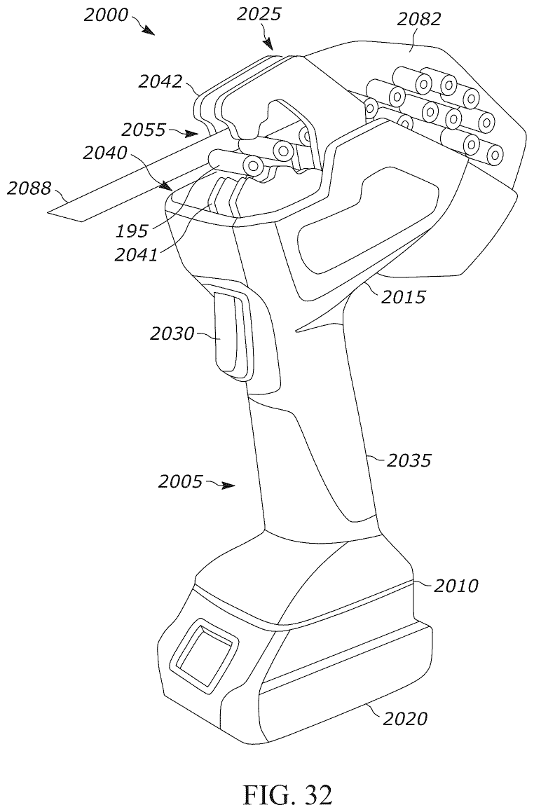

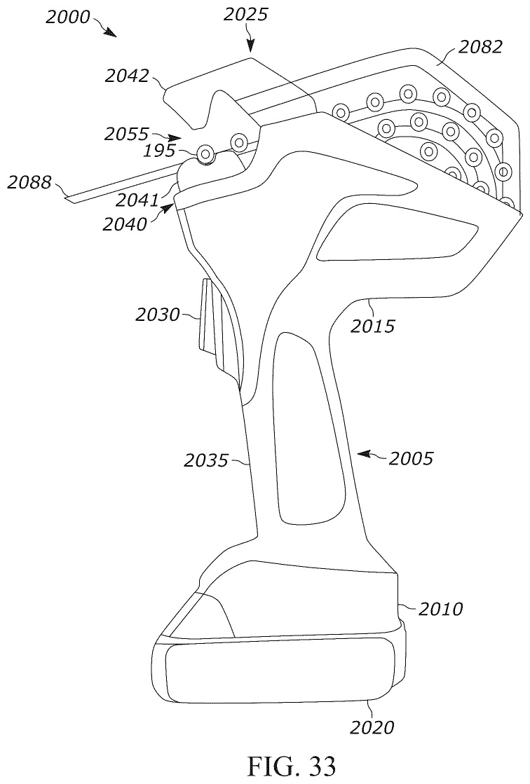

FIGS. 32 and 33 illustrates an eleventh example of a handheld power tool 2000 (e.g., a crimping tool), which may be similar to any one of the above-described power tools. The power tool 2000 may include a body 2005 with a first end 2010 and a second end 2015, which may have a pistol shape where an axis that extends along the body 2005 does not intersect the first end 2010 and the second end 2015.

The first end 2010 may include electrical contacts (not shown). A battery 2020 (e.g., a power tool battery pack) may be connected to the electrical contacts at the first end 2010. In the illustrated example, the battery 2020 may be removable from the first end 2010 and replaceable and/or rechargeable. In other examples, an electrical cord (not shown) may be disposed proximate to the first end to provide electrical power to the power tool 2000.

In some forms, the body 2005 may be at least partially formed from an injection-molded material (e.g., plastic). In some forms, the body 2005 may be at least partially constructed using additive manufacturing. In some forms, the body 2005 may be machined. In other examples, one or more of these manufacturing methods may be used together.

The second end 2015 may include tool head 2025 which may be at least partially movable relative to the remainder of the body 2005. As described in more detail below, the tool head 2025 may be selectively operable to provide a crimping force.

In certain examples, the body 2005 may include a grasping portion 2035 disposed proximate to a trigger or actuator 2030. The body 2005 may be held by a technician at the grasping portion 2035 when the power tool 2000 is in use. The grasping portion 2035 may be a different material and/or texture to assist in permitting the technician to grip the body 2005.

As shown in FIGS. 32 and 33, the tool head 2025 may include a frame 2040 formed from a substantially rigid material (e.g., metal, rigid plastic, etc.). The illustrated frame 2040 may include a space or working area 2055 that may be formed between a pair of movably jaws 2041, 2042. Dies may be connected to the movable jaws 2041, 2042 to correspond to different-sized terminals.

In some forms, a drive system may be disposed within the body 2005. Although not illustrated, the drive system of the power tool 2000 may be similar to any of the above-described drive systems (e.g., include a sprocket). The drive system may drive a spool that is located within the housing 2082, which may be disposed proximate to the second end 2015. Material may be wrapped around the spool. For example, a mylar strip (or other similar material) may be wrapped around the spool. Terminals 195 may be coupled to the strip of material. The spool may come pre-wrapped with the strip of material and the spool may be removed and replaced when the material is completely unwound. In other examples, after the first strip of material is completely unwound, a technician can wind a new strip of material around the spool.

With continued reference to FIGS. 32 and 33, the body 2005 proximate to the second end 2015 may include a channel. The housing 2082 may be a cover that is removably positionable within the channel. This may permit a technician to access the interior of the channel and add additional terminals 195. In the illustrated example, the housing 2082 may be transparent or translucent, which may help a technician observe how many terminals are remaining.

In some forms, the housing 2082 may be selectively disconnected by disengaging the housing 2082 from the channel (e.g., decoupling a snap fit connection) and pulling the housing 2082 away from the body 2005 (e.g., along a direction parallel to an axis that extends through a handle of the tool). In other examples, the housing 2082 may be removed by sliding it relative to the body 2005. In still other examples, the housing 2082 may be pivotably connected to the body 2005.

In use, the technician may load the strip of material and the attached terminals 195 into the cavity. Once the strip of material is positioned within the cavity, the technician may adjust the length of the material 2088 and the position of the first terminal 195 so that the first terminal 195 is properly positioned for the first crimping cycle (e.g., between the jaws 2041, 2042). Conductors (e.g., wires) may be inserted into the terminal 195 prior to the jaws 2041, 2042 being moved. The first terminal 195 may be disposed in the working area 2055 between jaws 2041, 2042, which contact and crimp the first terminal 195 (see e.g., FIG. 32). This secures the conductors within the terminal 195. The technician may release the actuator and allow the jaws 2041, 2042 to return to their initial position. Movement of the jaws 2041, 2042 toward their initial position may advance the spool so that the next terminal 195 moves into the working area 2055. A hub within the housing 2082 containing the terminals 195 may rotate so that the next terminal is automatically moved into the working area 2055 between the open jaws 2041, 2042 (e.g., to awhile the subsequent crimp cycle).

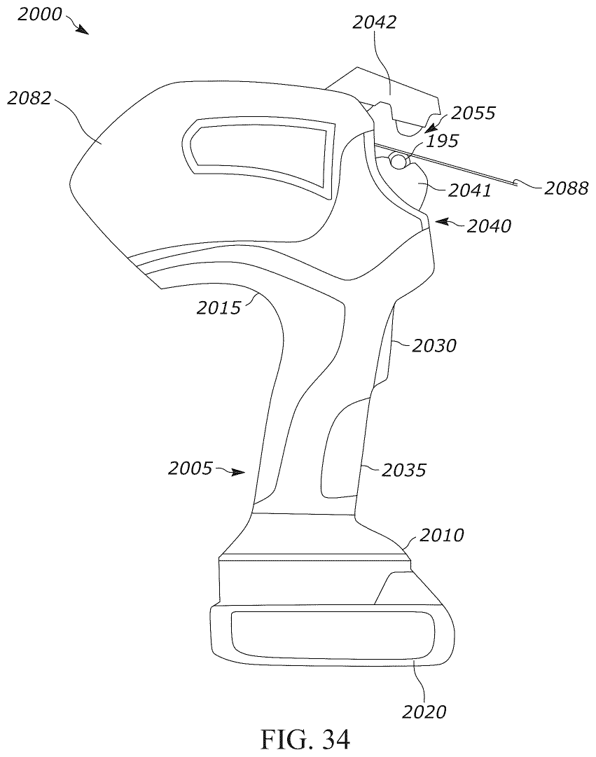

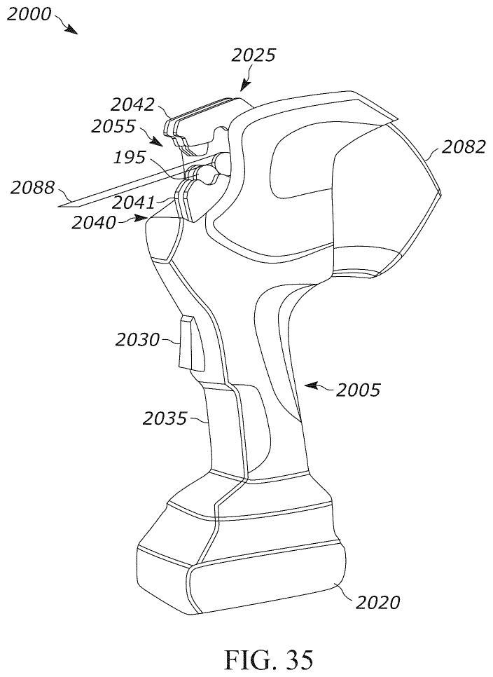

FIGS. 34 and 35 illustrate alternate examples of the power tool 2000. Specifically, the alternate examples include different housings 2082, which may permit different ways to disconnect the cover of the housing 2082 from the body 2005. For example, the housing 2082 in FIG. 34 may include a larger internal volume so that it is not reliant on the body 2005 to enclose the terminals 195. A technician may be able to decouple the housing 2082 from the body 2005 by pulling the housing 2082 away from the jaws 2041, 2042. In FIG. 35, the housing 2082 may have a similar shape but the body 2005 may be larger and may at least partially surround the connected housing 2082. The housing may similarly be disconnected by pulling in a direction away from the jaws 2041, 2042.

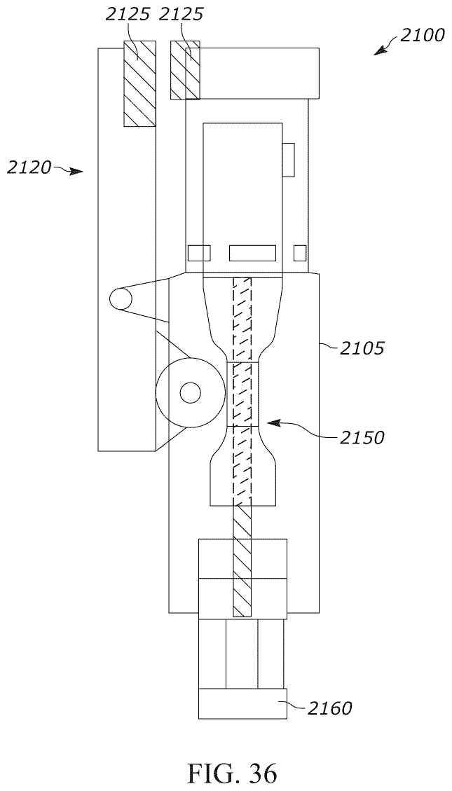

FIGS. 36 to 39 illustrate a twelfth example of a handheld power tool 2100 (e.g., a crimping tool), which may be similar to any one of the above-described power tools. For example, the handheld power tool 2100 may have a similar outer shape (e.g., a pistol shape) as the handheld power tool 100 (see e.g., FIG. 1). The power tool 2100 may include a body 2105 with a first end (not shown).

In some forms, the handheld power tool 2100 may include a crimp lever 2120 that is used to apply a crimping force to a terminal 195 via a die set 2125. As shown in FIG. 36, the crimp lever 2120 may be coupled to and positioned at least partially outside of the body 2105.

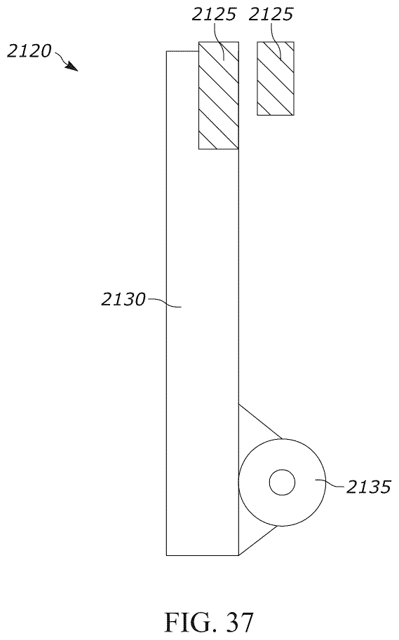

As shown in FIG. 37, the crimp lever 2120 may include an elongated body 2130 that has a rocker 2135 at one end and a die of the die set 2125 coupled at the other end. The body 2130 may be elongated and extend substantially along a length of the body 2105.

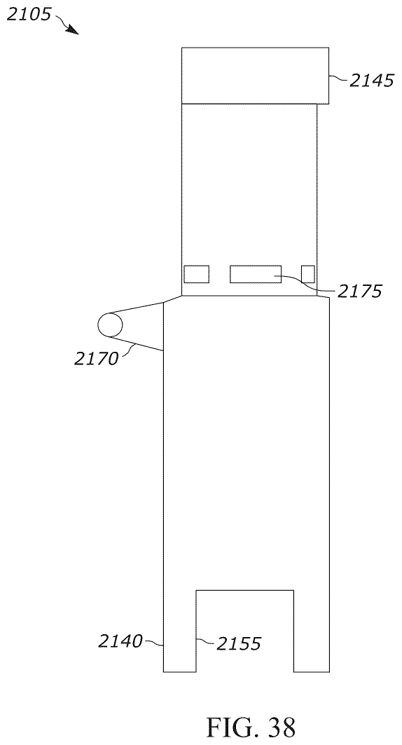

As shown in FIG. 38, the body 2105 may include a first end 2140 and a second end 2145 opposite to the first end 2140. In some forms, the second end 2145 of the body 2105 may receive one of the dies of the die set 2125. The body 2105 may have a hollow interior between the first and second ends 2140, 2145. As described in more detail below, an actuator 2150 may be disposed within the interior of the body 2105.

In some forms, the first end 2140 of the body 2105 may include a slot 2155. The slot 2155 may be centered on the body 2105 and may have a substantially rectangular shape when viewed from above. As shown in FIG. 36, the slot 2155 may receive a motor 2160 and an end of the actuator 2150 (e.g., a drive screw 2165).

In some forms, the body 2105 may include a pivot point 2170 disposed between the first and second ends 2140, 2145. The pivot point 2170 may connect to the crimp lever 2120 between the rocker 2135 and the die set 2125. In the illustrated example, the pivot point 2170 may be connected to the elongated body 2130 more proximate to the rocker 2135. The body 2105 may also include an opening proximate to the pivot point 2170 that can receive the rocker 2135.

In some forms, the body 2105 may include one or more slots 2175. The slots 2175 may be used to receive the mylar strips that carry the to-be-crimped terminals 195.

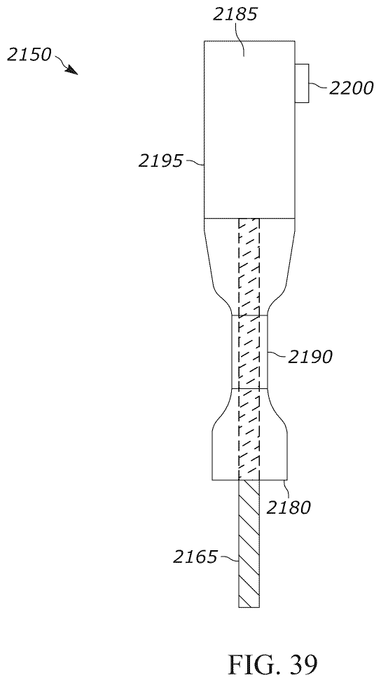

As shown in FIG. 39, the actuator 2150 includes a first end 2180 and a second end 2185 opposite to the first end 2180. The drive screw 2165 extends from the first end 2180. The body of the actuator 2150 may include a first or cam portion 2190 and a second or guide portion 2195. In the illustrated example, the cam portion 2190 may be proximate to the first end 2180 and adjacent to the guide portion 2195, which is proximate to the second end 2185. The cam portion 2190 may have a narrower width portion, which can receive the rocker 2135. The guide portion 2195 may include a latch 2200 extends from the body of the actuator 2150 proximate to the second end 2185. As described in more detail below, the latch 2200 may cause the guide portion 2195 to rotate.

In use, the power tool 2100 may be actuated with a trigger or similar mechanism as described in any of the previous examples. Upon actuation, the motor causes the drive screw 2165 to rotate, which in turn causes the remainder of the actuator 2150 to move along the length of the drive screw 2165. For example, the drive screw 2165 may cause the actuator 2150 to move toward the second end 2145 of the body 2105. Movement of the actuator 2150 may engage the rocker 2135 and cause the crimp lever 2120 to move about pivot point 2170. The crimp lever 2120 moves so that the dies of the die set 2125 engage and can crimp a terminal 195 positioned in between.

Similar to the examples described above, the power tool 2100 may automatically feed uncrimped terminals into position between the die set 2125 to be crimped. For example, the terminals 195 may be wrapped around the guide portion 2195 and proximate to the latch 2200. After the power tool 2100 is actuated and a terminal is crimped, the actuator 2150 may move in the opposite direction along the drive screw 2165 and pivot back toward its initial position (e.g., where the die sets 2125 are spaced apart). As this occurs, the latch 2200 may be engaged and to cause the guide portion 2195 to rotate, thereby moving the next uncrimped terminal toward the die set 2125. The process is repeated with the power tool 2100 being actuated again so that the next terminal is crimped.

In other examples, the uncrimped terminals may be stored in a magazine and feed into position between the dies of the die set 2125. In some examples, the magazine may project away from the second end 2145 of the body 2105 and along an axis parallel to the actuator 2150. Although, the magazine may extend in a different direction in other examples (e.g., perpendicular to the axis of the actuator). The magazine used with the power tool 2100 may be similar to any of the magazines described above.

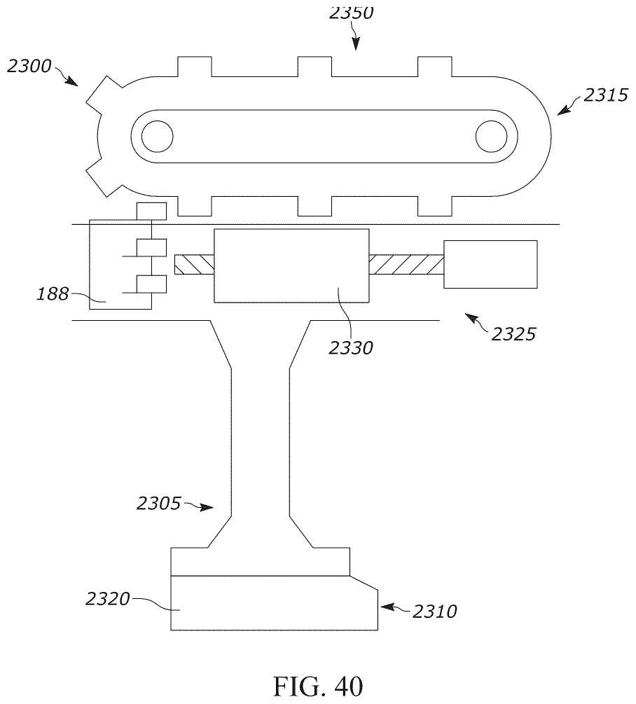

FIGS. 40 to 42 illustrate a thirteenth example of a handheld power tool 2300 (e.g., a crimping tool), which may be similar to any one of the above-described power tools. For example, the handheld power tool 2300 may have a similar outer shape (e.g., a pistol shape) as the handheld power tool 100 (see e.g., FIG. 1). The power tool 2300 may include a body 2305 with a first end 2310 and a second end 2315. The first end 2310 may support a battery 2320 and the second end 2315 may include the working portion.

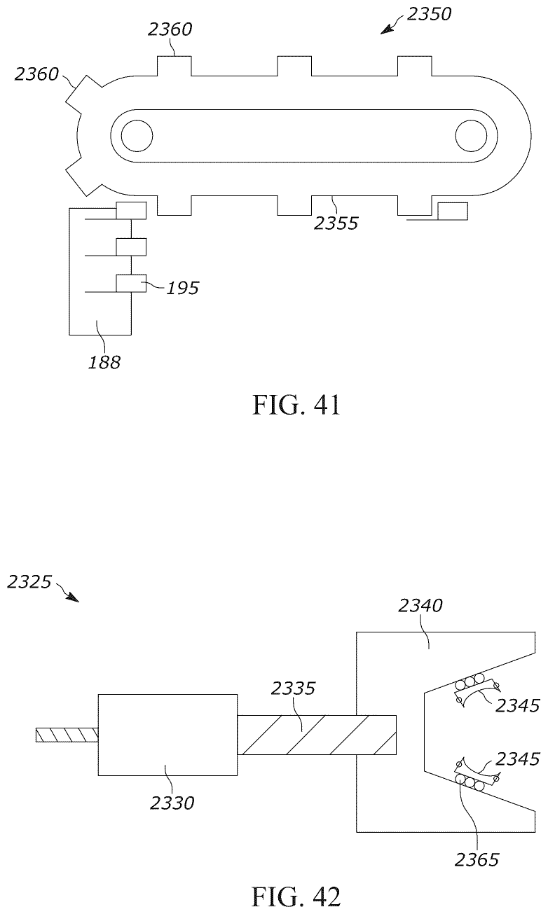

As shown in FIGS. 40 and 41, the power tool 2300 may include a drive assembly 2325, which may be similar to drive system 172. The power tool 2300 may also include a belt system 2350 that can be used to automatically feed uncrimped terminals to be crimped by the drive assembly 2325. The belt system 2350 may include a belt 2355 with a plurality of teeth or sprockets 2360. As described in more detail below, the sprockets 2360 may be used to carry uncrimped terminals toward the working portion.

As shown in FIG. 42, the drive assembly 2325 may include a motor 2330 that drives a lead screw 2335 and causes a pair of jaws 2340 to actuate. A pair of dies 2345 may be moved together to crimp a terminal.

In some forms, each die of the pair of dies 2345 may be situated on roller bearings 2365. The roller bearings 2365 permit the dies to move as the jaws 2340 move between an open and closed position. For example, the roller bearings 2365 may cause the pair of dies 2345 to move toward the end of the jaws 2340 when the jaws 2340 move toward the closed position to crimp the terminal.

In other examples, the power tool 2300 may include a single jaw 2340. For example, there may be a fixed piece that includes one of the dies 2325 and a single moving jaw that includes the other die. The single jaw 2340 may be movable as described above toward the fixed piece to similarly create a crimping force.

Returning to FIG. 40, uncrimped terminals may be stored behind the motor 2330. In the illustrated example, the terminals 195 may be stored on the mylar sheet 188 proximate to an end of the belt 2355. The mylar sheet 188 may pass by the belt 2355 so that a sprocket or tine 2360 can engage the terminal 195. More specifically, the mylar 188 may be wrapped around an axis that is substantially perpendicular to an axis around which the belt system 2350 moves.

In use, the power tool 2300 may be actuated causing the belt system 2350 to move. As the belt 2355 moves, the sprockets 2360 pass over the uncrimped terminals on the mylar 180. The sprockets 2360 may detach the topmost terminal from the mylar 180 and secure between adjacent sprockets 2360. The movement of the belt 2355 may move the uncrimped terminal toward the jaws 2340, where it will be positioned between the dies 2345 and crimped. The belt 2355 will continually bring terminals toward the jaws 2340 to allow for continuous crimping. The used mylar (e.g., that no longer contains a terminal 190) may pass out another side of the tool for removal.

In other examples, a magazine may replace the mylar. As described in other examples, the magazine may be spring loaded and may feed uncrimped terminals 190 into the space between the sprockets 2360 The belt may then similarly transport the uncrimped terminals 190 toward the jaws 2340.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various forms of the disclosure. Once armed with the present specification, routine experimentation is all that is needed to determine adjustments and modifications that will carry out the present disclosure.

The above forms are for illustrative purposes and are not intended to limit the scope of the disclosure or the adaptation of the features described herein. Those skilled in the art will also appreciate that various adaptations and modifications of the above-described preferred forms can be configured without departing from the scope and spirit of the disclosure. Therefore, it is to be understood that, within the scope of the appended claims, the example may be practiced other than as specifically described.

1. A handheld crimping tool comprising:
a tool body having a housing and a working end;
a pair of jaws movable relative to the working end between a closed position and an opened position;
a chamber disposed within the housing and configured to receive a plurality of terminals;
a drive system disposed within the chamber, wherein movement of the pair of jaws from the closed position to the opened position is configured to advance the drive system;
wherein movement of the pair of jaws toward the closed position is configured to crimp a first terminal of the plurality of terminals; and
wherein advancement of the drive system is configured to automatically index a successive terminal of the plurality of terminals toward the working end.

2. The handheld crimping tool of claim 1, further comprising a spool disposed within the chamber proximate to the working end, wherein the plurality of terminals is wrapped around the spool, and wherein the spool is connected to the drive system and configured to rotate to automatically index the successive terminal.

3. The handheld crimping tool of claim 2, wherein the spool is disposed between the pair of jaws and the working end.

4. The handheld crimping tool of claim 2, further comprising a power tool battery pack connected to the housing and configured to provide electrical power to the drive system, wherein the power tool battery pack includes a thickness, wherein the spool includes a radius, wherein the radius and the thickness are sized so that the spool and the power tool battery pack are each configured to contact a support surface during use.

5. The handheld crimping tool of claim 1, further comprising a photosensor configured to measure a size of each terminal of the plurality of terminals, wherein a measurement of the photosensor is configured to determine the angular distance of rotation of the spool.

6. The handheld crimping tool of claim 1, wherein the pair of jaws includes an upper jaw and a lower jaw, wherein the chamber extends along a length of the tool body, and wherein the plurality of terminals is configured to feed up toward the lower jaw.

7. The handheld crimping tool of claim 1, further comprising a tool stand movably coupled to the tool body, wherein the tool stand is movable between a first position against the body and a second position at least partially spaced from the body and configured to engage a support surface while in use.

8. A handheld crimping tool comprising:
a tool body having a channel and a working end;
a pair of jaws movable relative to the working end between a closed position and an opened position;
a cover removably connected to the tool body to enclose a chamber configured to receive a plurality of terminals;
a drive system disposed within the chamber, wherein movement of the pair of jaws from the closed position to the opened position is configured to advance the drive system;
wherein movement of the pair of jaws toward the closed position is configured to crimp a first terminal of the plurality of terminals; and
wherein advancement of the drive system is configured to automatically index a successive terminal of the plurality of terminals toward the working end.

9. The handheld crimping tool of claim 8, wherein the cover is transparent or translucent.

10. The handheld crimping tool of claim 8, further comprising a spool disposed within the chamber proximate to the working end, wherein the plurality of terminals is wrapped around the spool, and wherein the spool is connected to the drive system and configured to rotate to automatically index the successive terminal.

11. The handheld crimping tool of claim 10, wherein the spool is disposed between the pair of jaws and the working end.

12. The handheld crimping tool of claim 8, further comprising a power tool battery pack connected to the housing and configured to provide electrical power to the drive system, wherein the power tool battery pack includes a thickness, wherein the spool includes a radius, wherein the radius and the thickness are sized so that the spool and the power tool battery pack are each configured to contact a support surface during use.

13. The handheld crimping tool of claim 8, further comprising a photosensor configured to measure a size of each terminal of the plurality of terminals, wherein a measurement of the photosensor is configured to determine the angular distance of rotation of the spool.

14. The handheld crimping tool of claim 8, wherein the pair of jaws includes an upper jaw and a lower jaw, wherein the chamber extends along a length of the tool body, and wherein the plurality of terminals is configured to feed up toward the lower jaw.

15. The handheld crimping tool of claim 8, further comprising a tool stand movably coupled to the tool body, wherein the tool stand is movable between a first position against the body and a second position at least partially spaced from the body and configured to engage a support surface while in use.

16. A handheld crimping tool comprising:
a tool body having a channel and a working end;
a jaw element movable relative to the working end between a first position and a second position;
a cover removably connected to the tool body to enclose a chamber configured to receive a plurality of terminals;
a drive system disposed within the chamber, wherein movement of the jaw from the first position to the second position is configured to advance the drive system; and
a spool disposed within the chamber proximate to the working end, wherein the plurality of terminals is wrapped around the spool, and wherein the spool is connected to the drive system;
wherein movement of the jaw element toward the first position is configured to crimp a first terminal of the plurality of terminals; and
wherein advancement of the drive system is configured to rotate the spool to automatically index a successive terminal of the plurality of terminals toward the working end.

17. The handheld crimping tool of claim 16, wherein the cover is transparent or translucent.

18. The handheld crimping tool of claim 16, further comprising a power tool battery pack connected to the housing and configured to provide electrical power to the drive system, wherein the power tool battery pack includes a thickness, wherein the spool includes a radius, wherein the radius and the thickness are sized so that the spool and the power tool battery pack are each configured to contact a support surface during use.

19. The handheld crimping tool of claim 16, further comprising a photosensor configured to measure a size of each terminal of the plurality of terminals, wherein a measurement of the photosensor is configured to determine the angular distance of rotation of the spool.

20. The handheld crimping tool of claim 16, wherein the jaw element is an upper jaw, the handheld crimping tool further includes a lower jaw, wherein the upper jaw and the lower jaw are configured to move toward one another to crimp the first terminal.
